(19) United States
(12) Patent Application Publication
(10) Pub. No.: US 2025/0039630 A1
(43) Pub. Date: Jan. 30, 2025

(54) SOUND GENERATION DEVICE, SOUND REPRODUCTION DEVICE, AND SOUND GENERATION METHOD

(71) Applicants: Akita Prefectural University, Akita (JP); Panasonic Holdings Corporation, Osaka (JP)

(72) Inventors: Masayuki NISHIGUCHI, Akita (JP); Yuki MIZUTANI, Akita (JP); Seigo ENOMOTO, Kyoto (JP); Tomokazu ISHIKAWA, Osaka (JP)

(21) Appl. No.: 18/915,935

(22) Filed: Oct. 15, 2024

Related U.S. Application Data
(63) Continuation of application No. PCT/JP2023/016481, filed on Apr. 26, 2023.

(30) Foreign Application Priority Data
Apr. 28, 2022 (JP) 2022-074548
Feb. 9, 2023 (JP) 2023-018244

(51) Int. Cl. H04S 7/00; H04R 5/033

(52) U.S. Cl. CPC H04S 7/304; H04R 5/033

(57) ABSTRACT

A sound generation device includes a direction obtainer and a panner. The direction obtainer obtains a sound-source direction of a sound source. The panner expresses the sound source, by applying a time shift and gain adjustment to the sound source to perform panning for distributing a signal of the sound source to a plurality of representative directions, based on the sound-source direction obtained by the direction obtainer.

### CROSS REFERENCE TO RELATED APPLICATIONS

This is a continuation application of PCT International Application No. PCT/JP2023/016481 filed on Apr. 26, 2023, designating the United States of America, which is based on and claims priority of Japanese Patent Applications No. 2022-074548 filed on Apr. 28, 2022 and No. 2023-018244 filed on Feb. 9, 2023. The entire disclosures of the above-identified applications, including the specifications, drawings and claims are incorporated herein by reference in their entirety.

### FIELD

The present disclosure relates in particular to a sound generation device that creates sound signals that are reproduced by headphones, for instance, a sound reproduction device, and a sound generation method.

### BACKGROUND

Conventionally, there have been virtual reality (VR) headphones and head mounted displays (HMDs) that can reproduce content such as movies, VR, and augmented reality (AR). Such VR headphones and HMDs use head-related t functions (hereinafter, referred to as “HRTFs”) that have taken into consideration a direction from a listener to a sound source, to localize a sound outside the head, so that the listener can feel a wider sound field.

As an example of a sound processing device that calculates such HRTFs, Patent Literature (PTL) 1 discloses a device that includes a sensor that outputs a detection signal according to an orientation of the head of a listener, a sensor signal processor that obtains a direction, in which the head of the listener is directed, by computation based on the detection signal and outputs direction information indicating the obtained direction, a sensor output corrector that corrects the direction information output by the sensor signal processor, based on average information resulting from averaging the direction information, a head-related transfer function corrector that corrects a head-related transfer function obtained in advance, according to the corrected direction information, and a sound image localization processor that performs, on a sound signal to be reproduced, sound image localization processing according to the corrected head-related transfer function.

Here, conventionally, when a three-dimensional sound for which an HRTF is used is reproduced using headphones, a head-related impulse response (HRIR) that is a representation of an HRTF on a time axis has been often used in computing an actual sound signal.

### CITATION LIST

### Patent Literature

PTL 1: Japanese Unexamined Patent Application Publication No. 2021-5822

### SUMMARY

### Technical Problem

In the conventional sound processing device as stated in PTL 1, an HRIR is convolved for each sound source, and thus if the number of sound sources is high, it is necessary to convolve an HRIR for each of the sound sources, which results in an increase in the computation load.

The present disclosure has been conceived in light of such circumstances, and is to address the above problem.

### Solution to Problem

A sound generation device according to an aspect of the present disclosure includes: a direction obtainer that obtains a sound-source direction of a sound source; and a panner that expresses the sound source, by applying a time shift and gain adjustment to the sound source to perform panning for distributing a signal of the sound source to a plurality of representative directions, based on the sound-source direction obtained by the direction obtainer.

### Advantageous Effects

The present disclosure can provide a sound generation device that can generate a stereophonic sound of an HRIR while the computation load is reduced, since a sound source is synthesized by panning in a particular representative direction, based on a direction of the sound source, to equivalently generate an HRIR in (for) the sound-source direction by using an HRIR in the representative direction.

### BRIEF DESCRIPTION OF DRAWINGS

FIG. 1 illustrates a control configuration of a sound reproduction device according to Embodiment 1.

FIG. 2 is a conceptual diagram illustrating concept of synthesis of head-related impulse responses (HRIRs) by panning illustrated in FIG. 1.

FIG. 3 is a flowchart illustrating sound reproduction processing according to Embodiment 1.

FIG. 4 is a diagram for explaining synthesis of HRIRs in the sound reproduction processing according to Embodiment 1.

FIG. 5 illustrates a control configuration of another sound reproduction device according to Embodiment 1.

FIG. 6 is a graph illustrating results of comparing signal-noise ratios (SNRs) using head-related transfer functions (HRTFs) (four directions_oblique, right ear) of a person himself/herself according to Embodiment 1.

FIG. 7 is a graph illustrating results of comparing SNRs using HRTFs (four directions_oblique, left ear) of a person himself/herself according to Embodiment 1.

FIG. 8 is a graph illustrating results of comparing SNRs using HRTFs (four directions_vertical/horizontal, right ear) of a person himself/herself according to Embodiment 1.

FIG. 9 is a graph illustrating results of comparing SNRs using HRTFs (four directions_vertical/horizontal, left ear) of a person himself/herself according to Embodiment 1.

FIG. 10 is a graph illustrating results of comparing SNRs using HRTFs (six directions, right ear) of a person himself/herself according to Embodiment 1.

FIG. 11 is a graph illustrating results of comparing SNRs using HRTFs (six directions, left ear) of a person himself/herself according to Embodiment 1.

FIG. 12 is a graph illustrating results of localization experiments (true values) in which subjective localization was conducted according to Embodiment 1.

FIG. 13 is a graph illustrating results of localization experiments using representative points in (1) four directions_oblique stated above according to Embodiment 1.

FIG. 14 is a graph illustrating results of localization experiments using representative points in (2) four directions_vertical/horizontal stated above according to Embodiment 1.

FIG. 15 is a graph illustrating results of localization experiments using representative points in (3) six directions stated above according to Embodiment 1.

FIG. 16 is a graph illustrating results of experiments of subjective quality evaluation (one type of male voice) by Multiple Stimuli with Hidden Reference and Anchor (MUSHRA) according to Embodiment 1.

FIG. 17 is a graph illustrating results of comparing SNRs using FABIAN (four directions_oblique) according to Embodiment 1.

FIG. 18 is a graph illustrating results of comparing SNRs using FABIAN (four directions_vertical/horizontal) according to Embodiment 1.

FIG. 19 is a graph illustrating results of comparing SNRs using FABIAN (six directions) according to Embodiment 1.

FIG. 20 is a graph illustrating results of comparing SNRs using FABIAN (three types, right ear) according to Embodiment 1.

FIG. 21 is a graph illustrating results of comparing SNRs using FABIAN (three types, left ear) according to Embodiment 1.

FIG. 22 is a graph illustrating results of comparing SNRs using FABIAN (only in four directions, right ear) according to Embodiment 1.

FIG. 23 is a graph illustrating results of comparing SNRs using FABIAN (only in four directions, left ear) according to Embodiment 1.

FIG. 24 is a graph illustrating time shifts made by integral multiple in panning (four directions_oblique, right ear) using FABIAN according to Embodiment 1.

FIG. 25 is a graph illustrating time shifts made by integral multiple in panning (four directions_oblique, left ear) using FABIAN according to Embodiment 1.

FIG. 26 is a graph illustrating time shifts made by integral multiple in panning (four directions_vertical/horizontal, right ear) using FABIAN according to Embodiment 1.

FIG. 27 is a graph illustrating time shifts made by integral multiple in panning (four directions_vertical/horizontal, left ear) using FABIAN according to Embodiment 1.

FIG. 28 is a graph illustrating time shifts made by integral multiple in panning (six directions, right ear) using FABIAN according to Embodiment 1.

FIG. 29 is a graph illustrating time shifts made by integral multiple in panning (six directions, left ear) using FABIAN according to Embodiment 1.

FIG. 30 is a graph illustrating results of comparison for verifying, using SNRs, effects of a decimal shift (four directions_oblique, right ear) according to Embodiment 1.

FIG. 31 is a graph illustrating results of comparison for verifying, using SNRs, effects of a decimal shift (four directions_oblique, left ear) according to Embodiment 1.

FIG. 32 is a graph illustrating results of comparison for verifying, using SNRs, effects of a decimal shift (four directions_vertical/horizontal, right ear) according to Embodiment 1.

FIG. 33 is a graph illustrating results of comparison for verifying, using SNRs, effects of a decimal shift (four directions_vertical/horizontal, left ear) according to Embodiment 1.

FIG. 34 is a graph illustrating results of comparison for verifying, using SNRs, effects of a decimal shift (six directions, right ear) according to Embodiment 1.

FIG. 35 is a graph illustrating results of comparison for verifying, using SNRs, effects of a decimal shift (six directions, left ear) according to Embodiment 1.

FIG. 36 illustrates examples of comparing waveforms of HRIRs of a person himself/herself according to Embodiment 1.

FIG. 37 illustrates examples of comparing waveforms of FABIAN according to Embodiment 1.

FIG. 38 illustrates graphs for comparing waveforms to which frequency weights are applied according to Embodiment 2.

### DESCRIPTION OF EMBODIMENTS

A sound generation device according to Example 1 is a sound generation device including: a direction obtainer that obtains a sound-source direction of a sound source; and a panner that expresses the sound source, by applying a time shift and gain adjustment to the sound source to perform panning using a sound in a particular representative direction, based on the sound-source direction obtained by the direction obtainer.

A sound generation device according to Example 2 may be the sound generation device according to Example 1, in which a plurality of sound sources are present, the plurality of sound sources each being the sound source, a plurality of particular representative directions are directions for a plurality of representative points that are less in number than the plurality of sound sources, the particular representative directions each being the particular representative direction, and the panner synthesizes a sound image of the plurality of sound sources by using sounds in the plurality of particular representative directions.

A sound generation device according to Example 3 may be the sound generation device according to Example 2, in which the panner applies, to the plurality of sound sources, time shifts calculated to maximize a cross-correlation between head-related impulse responses in sound-source directions of the plurality of sound sources and head-related impulse responses in the plurality of particular representative directions, or minus-sign time shifts resulting from assigning a minus sign to the time shifts.

A sound generation device according to Example 4 is may be the sound generation device according to Example 3, in which a result obtained by calculating the cross-correlation after applying a weighting filter on a frequency axis is used for the time shifts, gains, or the time shifts and gains.

A sound generation device according to Example 5 may be the sound generation device according to any one of Examples 2 to 4, in which for each of the plurality of representative points, the panner applies a gain to each of the plurality of sound sources to which the time shifts have been applied, the gain being set for the sound source and the particular representative direction for the representative point.

A sound generation device according to Example 6 may be the sound generation device according to any one of Examples 1 to 5, in which when a head-related impulse response (HRIR) vector in one of the plurality of sound-source directions is synthesized by using a sum of HRIR vectors in the plurality of representative directions to obtain a synthesized HRIR vector, the panner uses the gain calculated to cause an error signal vector between the synthesized HRIR vector and the HRIR vector in the one of the sound-source directions to be orthogonal to each of the HRIR vectors in the plurality of representative directions.

A sound generation device according to Example 7 may be the sound generation device according to any one of Examples 1 to 6, in which the panner uses the gain calculated to minimize an L2 norm or energy of an error signal vector between a synthesized head-related impulse response (HRIR) vector and an HRIR vector in one of the plurality of sound-source directions.

A sound generation device according to Example 8 may be the sound generation device according to Example 6 or 7, in which a result obtained by applying a weighting filter on a frequency axis is used for the error signal vector.

A sound generation device according to Example 9 may be the sound generation device according to any one of Examples 2 to 5, in which the panner uses the gain corrected to maintain an energy balance between head-related impulse responses of left and right ears from a position of one of the plurality of sound sources, in head-related impulse responses resulting from substantially synthesizing, by panning, head-related impulse responses from the plurality of representative points.

A sound generation device according to Example 10 may be the sound generation device according to any one of Example 4, 5, or 9, in which the panner applies the time shifts to the plurality of sound sources, treats signals to each of which the gain has been applied, as representative-point signals present at positions of the plurality of representative points, and convolves head-related impulse responses at the positions of the plurality of representative points with a sum signal of the representative-point signals equal in number to the plurality of sound sources, to generate a signal that reaches an ear of a listener.

A sound generation device according to Example 11 may be the sound generation device according to any one of Examples 1 to 10, in which in the time shifts, a shift by a decimal of sampling is permitted.

A sound generation device according to Example 12 may be the sound generation device according to any one of Examples 1 to 11, in which a reproduction high-frequency emphasis filter compensates a tendency for a high-frequency range to attenuate. A sound generation device according to Example 13 may be the sound generation device according to any one of Examples 1 to 12, in which the sound source is a sound signal of content or a sound signal of a participant of a remote call, and the direction obtainer obtains a direction of the sound source in a view from a listener.

A sound reproduction device according to Example 14 is a sound reproduction device including: the sound generation device according to any one of Examples 1 to 13; and a sound outputter that outputs a sound signal generated by the sound generation device.

A sound generation method according to Examine 15 is a sound generation method executed by a sound generation device, the sound generation method including: obtaining a sound-source direction of a sound source; and expressing the sound source, by applying a time shift and gain adjustment to the sound source to perform panning using a sound in a particular representative direction, based on the sound-source direction obtained.

A sound signal processing program according to Examine 16 is a sound signal processing program executed by a sound generation device, the sound signal processing program causing the sound generation device to: obtain a sound-source direction of a sound source; and express the sound source, by applying a time shift and gain adjustment to the sound source to perform panning using a sound in a particular representative direction, based on the sound-source direction obtained.

### Embodiment 1

### [Control Configuration of Sound Reproduction Device 1]

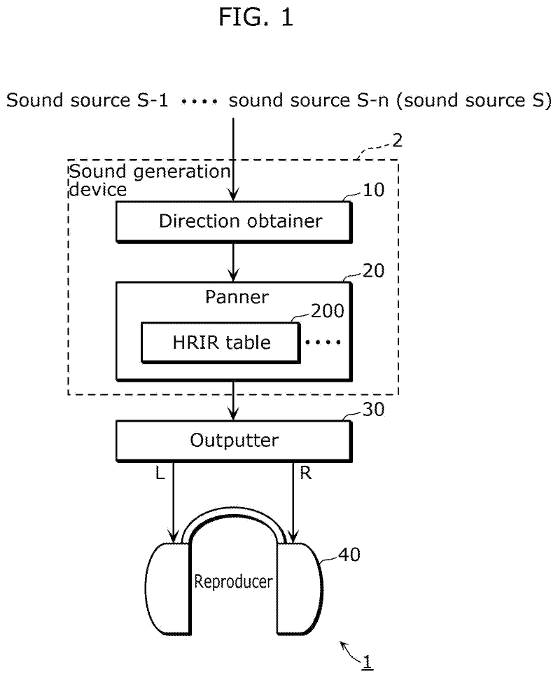

First, a control configuration of sound reproduction device 1 according to Embodiment 1 is to be explained with reference to FIG. 1.

Sound reproduction device 1 is a device that a listener wears and can reproduce sound, to reproduce sound signals of content that is data such as videos, sounds, and text or to talk with someone in a remote area.

Specifically, examples of sound reproduction device 1 include a stereophonic reproduction device embodied by a personal computer (PC) or a smartphone to which headphones are connected, a dedicated game device, a content reproduction device that reproduces content stored in an optical medium or a flash memory card, a device in a movie theater or a public viewing site, headphones that include a dedicated decoder and a head-tracking sensor, a head-mounted display (HMD) for virtual reality (VR), augmented reality (AR), or mixed reality (MR), a headphone-type smartphone, a TV (video) conference system, a device for teleconferences, a device that helps hear sounds, a hearing aid, and other home electrical appliances.

Sound reproduction device 1 according to the present embodiment includes direction obtainer 10, panner 20, outputter 30, and reproducer 40, as a control configuration. In the present embodiment, direction obtainer 10 and panner 20 are configured as sound generation device 2 that generates sound signals.

Here, in the present embodiment, three-dimensional sounds are generated from sound sources S-1 to S-n that are sound signals (sound source signals, target signals). One of plural sound sources S-1 to S-n is also simply referred to as “sound source S” in the following. As sound source S according to the present embodiment, a sound signal of content or a sound signal of a participant of a remote call, for instance, can be used.

Examples of such content may include various types of content such as games, movies, VR, AR, and MR. The movies include performance of a musical instrument and a speech, for instance. In this case, as sound source S, a sound signal that originates from an object such as an instrument, a vehicle, or a game character (hereinafter, simply referred to as “an object, for instance”) or a sound signal of a person who is a source of sound, such as an actor, a narrator, a comic storyteller, a storyteller, or another type of speaker can be used. These sound signals have a spatial arrangement relation that is set, within content.

When sound source S is a sound signal of a participant of a remote call, a sound signal of a sound produced by a user (participant) of various types of messengers or application software (hereinafter, simply referred to as “app”) for video conferences of a personal computer (PC) or a smartphone, for instance, can be used. Such sound signals, for instance, may be obtained by a microphone of a headset, for instance, or by a device fixed on a desk, for instance. The orientation of a head of a participant within a camera or an orientation of an avatar provided in a virtual space, for instance, may be added as direction information. Furthermore, sound sources S may be sound signals, for instance, from participants of a remote conference held using a TV conference system, for instance, between one-to-one, one-to-multiple, or multiple-to-multiple locations. Also in this case, the orientations of participants of the talks relative to cameras may be set as direction information.

In any of the cases, a sound signal recorded using a microphone, for instance, that is connected to a network or connected directly can be used as sound source S. Also in this case, direction information may be added to the sound signal. An arbitrary combination of sound signals of such content as stated above or remote participants may be used. Furthermore, in the present embodiment, a sound signal of such sound source S can also serve as a “target signal” for reproducing the direction of stereophony.

Direction obtainer 10 obtains a sound-source direction of sound source S. In the present embodiment, direction obtainer 10 obtains the direction of sound source S relative to the front direction of a listener. Furthermore, direction obtainer 10 may obtain the direction of a listener relative to a radiation direction of sound source S. Specifically, direction obtainer 10 obtains the direction of sound source in a view from the listener. In addition, direction obtainer 10 may obtain the direction of a listener in a view from sound source S.

Here, direction information indicating a direction when a sound is generated is calculated for or set in sound source S according to the present embodiment. Accordingly, direction obtainer 10 obtains a radiation direction of a sound according to sound source S. In the present embodiment, for example, direction obtainer 10 can obtain the orientation of the head of a participant who provides sound source S. Direction obtainer 10 can obtain, also for a listener, the orientation of the head of the listener, by head tracking implemented by a gyro sensor, for instance, of an HMD or a smartphone or based on direction information indicating, for instance, the orientation of an avatar in a virtual space.

Direction obtainer 10 can calculate the orientations of both sound source S and a listener in the arrangement of a space including a virtual space, based on such information on directions.

Panner 20 performs panning for expressing sound sources S, by applying time shifts and gain adjustment to sound sources S, to perform panning using a sound in a particular representative direction, based on sound-source directions of sound sources S (target signals) obtained by direction obtainer 10. Specifically, panner 20 synthesizes sound sources S (target signals) by panning in a representative direction that approximates to the sound-source direction of sound source S. Accordingly, panner 20 equivalently generates an HRIR in the sound-source direction of sound source S. Here, in the present embodiment, “equivalent” and “equivalently” refer to a substantially same signal having an error of a certain degree or less, as shown by Examples stated below. Specifically, panner 20 equivalently generates an HRIR in (for) a direction, by panning sound source S, through synthesizing HRIRs in directions closest to a sound-source direction of sound source S or HRIRs that are most similar to an HRIR in the sound-source direction. In the present embodiment, this direction is explained as a “particular representative direction” (hereinafter, simply referred to as a “representative direction”) explained below. Accordingly, this reduces an amount of computation for generating a signal that reaches an ear.

Thus, panner 20 synthesizes a sound image of sound sources S, using sounds in representative directions. As the representative directions, two or three directions may be used. Specifically, panner 20 can integrate sound sources S to representative points that are less in number than sound sources S, and can synthesize a sound image using only HRIRs in representative directions for the representative points.

At this time, panner 20 calculates a time shift (a delay, a time delay) that maximizes a cross-correlation between an HRIR in a sound-source direction of sound source S and an HRIR in a representative direction. The processing hereinafter is performed, assuming that a signal after time shift, which results from applying the time shift obtained here or a time shift obtained by assigning a minus sign to the time shift is in a representative direction.

In the time shift, a time shift that takes time shorter than a sampling frequency (that is a shift whose sampling position is indicated by a decimal, and hereinafter referred to as a “decimal shift”) may be permitted. This decimal shift may be applied by oversampling.

Here, panner 20 calculates a sum of results obtained by convolving, with HRIRs at each representative point, values calculated for the representative point by applying gains to signals in the representative direction resulting from applying time-shifts to sound sources S, to synthesize a signal equivalent to a result obtained by convolving sound sources S with HRIRs in sound-source directions.

On the other hand, when an HRIR (a vector) in a sound source direction is synthesized by using a sum of HRIRs (vectors) in representative directions to obtain a synthesized HRIR, panner 20 may calculate a gain that causes an error signal vector between the synthesized HRIR (vector) and the HRIR in the sound-source direction to be orthogonal to each of the HRIRs (vectors) in the representative directions. Note that an HRIR (vector) is a comparison of a time waveform of the HRIR to a vector. Hereinafter, such an HRIR (vector) is also referred to as an “HRIR vector”.

Panner 20 corrects the gain to maintain an energy balance between HRIRs of left and right ears from the position of one of the sound sources, by using an HRIR resulting from substantially synthesizing, by panning, HRIRs from the representative points. Thus, panner 20 may correct the gain to maintain an energy balance between HRIRs of left and right ears of a listener based on sound sources S, by using an HRIR substantially synthesized by panning.

In the present embodiment, panner 20 can calculate, for each of the sound-source directions of sound sources S, a gain value of a gain of an HRIR in a representative direction and a time shift value corresponding to a time of the time shift of the HRIR, and store the gain value and the time shift value into HRIR table 200 explained later.

Then, using time shifts and gain values for the sound-source directions of sound sources S, panner 20 applies a time shift and a gain to each of sound sources S, and obtains a sum signal by making a sum of the results. Panner 20 treats the sum signal as being present at a position of a representative point. Panner 20 can generate a signal that reaches an ear of a listener, by convolving the sum signal with an HRIR at the position of the representative point.

Outputter 30 outputs a sound signal generated by sound generation device 2. In the present embodiment, for example, outputter 30 includes a digital-to-analog (D/A) converter and an amplifier for headphones, for instance, and outputs a sound signal as a reproduction sound signal for reproducer 40 that is headphones. Here, a reproduction sound signal may be a sound signal that a listener can hear by digital data, which is decoded based on information included in content, being reproduced by reproducer 40, for example. Outputter 30 may encode a sound signal and output the encoded sound signal as a sound file or streaming sound, so as to reproduce the signal.

Reproducer 40 reproduces the reproduction sound signal output by outputter 30. Reproducer 40 may include, for instance, a loudspeaker that includes an electromagnetic driver for headphones and earphones and a diaphragm (hereinafter referred to as a “loudspeaker, for stance”), and earmuffs or earpieces that a listener wears.

Reproducer 40 may also be able to cause the loudspeaker to output a digital reproduction sound signal maintained as a digital signal or an analog sound signal converted by a D/A converter, so that a listener can hear a sound. Reproducer 40 may separately output a sound signal to an HMD headphones or earphones, for instance, that the listener is wearing.

HRIR table 200 is data of HRIRs at representative points that panner 20 selects. Furthermore, HRIR table 200 includes values for synthesizing HRIRs by panning, which are calculated by panner 20 explained later.

Specifically, HRIR table 200 includes, as the values, gain values calculated, for each of the representative points, for sound-source directions at 2-degree intervals out of 360-degree full circumference, for example. As the gain values, for example, when panning is performed in two left and right directions for two representative points, two gain values (value A and value B) for each sound-source direction may be used, whereas when panning is performed in three directions that include an elevation-angle direction, three gain values (value A, value B, and value C) may be used.

Furthermore, HRIR table 200 may include time shift values for applying time shifts to sound sources S. The time shift values may include decimal shift values for applying decimal shifts by performing oversampling on sound sources S. HRIR table 200 can store therein the time shift values in association with the gain values.

The gain values and the time shift values can be calculated offline in advance.

### [Hardware Configuration of Sound Reproduction Device 1]

Sound reproduction device 1 includes control means (controllers) such as, for example, an application specific processor (ASIC), a digital signal processor (DSP), a central processing unit (CPU), a micro processing unit (MPU), and a graphics processing unit (GPU), as various circuits.

Furthermore, sound reproduction device 1 may include, as storage means (a storage), a storage such as a semiconductor memory such as read only memory (ROM) or random access memory (RAM), a magnetic recording medium such as a hard disk drive (HDD), or an optical recording medium. As the ROM, a flash memory or another writable or write-once recording medium may be included. Furthermore, instead of an HDD, a solid state drive (SSD) may be included. Control programs according to the present embodiment and various types of content may be stored in the storage. Among these, the control programs are programs for implementing various functional configurations including a sound signal processing program and methods according to the present embodiment. The control programs include built-in programs such as firmware, an operating system (OS), and an app.

Examples of the various types of content include data on a movie or music, a game, an audio book, data on an electronic book for which speech synthesis can be performed, television or radio broadcast data, various types of sound data that relates to car navigation and operating instructions of various home electric appliances, entertainment content that includes VR, AR, or MR, for instance, and other data that can be audibly output. In addition, background music (BGM) and sound effects of games, Musical Instrument Digital Interface (MIDI) files, audio call data of a mobile phone or a transceiver, and synthetic sound data of text messages in Messenger can also be considered as content. Such content may be obtained by being downloaded in a file or a data chunk transferred in a wired or wireless manner, or may be gradually obtained by streaming.

An app according to the present embodiment may be an app for reproducing content such as Media Player, Messenger, or an app for video conferencing, for instance.

Sound reproduction device 1 may include a Global Navigation Satellite System (GNSS) receiver that calculates a direction in which a listener is facing, a detector for a direction of a position in a room, a direction calculation means that can perform head tracking and includes an acceleration sensor, a gyro sensor, a magnetic field sensor, or the like, and a circuit that converts output from such a sensor into direction information.

Furthermore, sound reproduction device 1 may include a display such as a liquid crystal display or an organic electroluminescent (EL) display, an input receiver such as a button, a keyboard, or a pointing device such as a mouse or a touch panel, and an interface that allows connection to various devices in a wireless or wired manner. Among these, the interface may include an interface such as a flash memory medium including a microSD (registered trademark) card or a USB (Universal Serial Bus (USB)) memory, and an interface such as a local area network (LAN) board, a wireless LAN board, a serial interface, or a parallel interface.

Sound reproduction device 1 can be embodied using hardware resources by the control means executing methods according to the present embodiment using various programs mainly stored in the storage. Note that some of or an arbitrary combination of the elements explained above may be configured in hardware or as a circuit, using an integrated circuit (IC), a programmable logic device, or a field-programmable gate array (FPGA).

### [Sound Reproduction Processing Performed by Sound Reproduction Device 1]

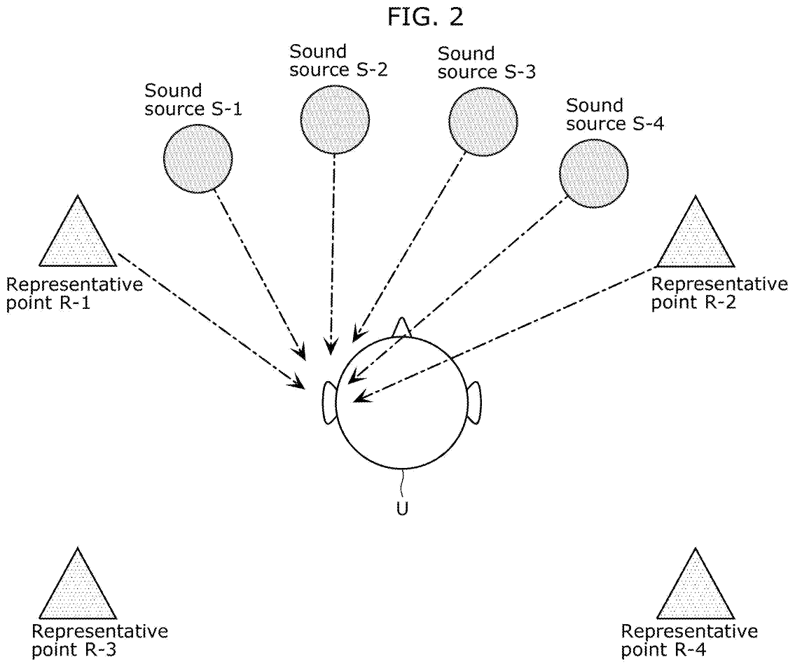

Next, sound reproduction processing performed by sound reproduction device 1 according to Embodiment 1 is to be explained with reference to FIG. 2 to FIG. 4.

First, with reference to FIG. 2, the sound reproduction processing according to the present embodiment is to be briefly explained.

In order to generate a sound that reaches an ear, which is a sound produced by sound source S, conventionally a head-related impulse response (HRIR) obtained by representing on a time axis a head-related transfer function (HRTF) that is a transfer function from each sound-source direction to the left or right ear has been convolved with each sound source S, and the results of the convolution have been added up. FIG. 2 illustrates an example of convolution of HRTFs for sound source S-1, sound source S-2, sound source S-3, and sound source S-4.

However, with this method, if the number of sound sources S is increased, the amount of computation increases due to convolution in which many product-sum operations are performed.

To address this, according to the sound reproduction processing according to the present embodiment, rather than directly convolving an HRIR from each of sound sources S to an ear with sound source S, sound sources S are synthesized and expressed by panning at representative points R-1 to R-n (hereinafter, if one of the representative points is indicated, the point is simply referred to as “representative point R”), thus convolving HRIRs from representative points R to ears. Accordingly, a sound image can be expressed by stereophony as if all of sound sources S are reproduced in ears. Accordingly, even if the number of sound sources S is increased, the number of times convolution is performed is determined only by the number of representative points, and thus computation for convolution is not increased.

In the example in FIG. 2, although four sound sources are provided, convolution is performed for two representative points R-1 and R-2 by expressing sound sources S-1 to S-4 by panning between representative point R-1 and representative point R-2. Furthermore, it is possible to perform panning by adding representative point R-3, representative point R-4, and others, for the rear side.

In the present embodiment, when panner 20 performs panning, a signal obtained by applying a time shift to sound source S (target signal) and applying a gain thereto may be treated as a representative-point signal present at a position of representative point R. Then, panner 20 calculates a sum signal of representative-point signals that are equal in number to sound sources S, which are to be integrated at representative point R, and convolves an HRIR at the position of the representative point with the sum signal, to generate a signal that reaches an ear of listener U. Thus, when there are n sound sources S that use one representative point R, panner 20 can generate an ear signal by convolving a result of adding up representative-point signals of n sound sources S with an HRIR at the position of representative point R.

The sound reproduction processing according to the present embodiment may be performed by the control means controlling and executing control programs stored in the storage means using hardware resources in cooperation with other elements or may be directly executed by circuits, mainly in sound reproduction device 1.

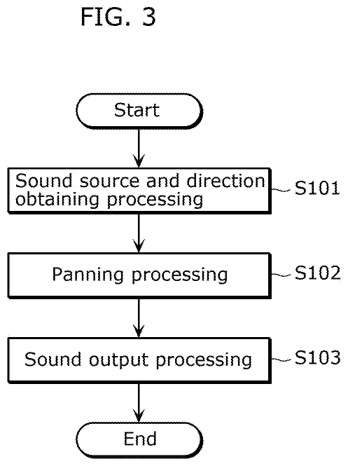

In the following, details of the sound reproduction processing are to be explained step by step, with reference to the flowchart in FIG. 3.

### (Step S101)

First, direction obtainer 10 of sound reproduction device 1 performs sound source and direction obtaining processing. Direction obtainer 10 obtains the direction of sound source S in a view from listener U.

Specifically, direction obtainer 10 obtains a sound signal (target signal) of sound source S. The sampling frequency and the quantization bit count of the sound signal are both arbitrary. In the present embodiment, an example in which a sound signal having a sampling frequency of 48 KHz and a quantization bit count of 16, for example, is used is to be explained. Furthermore, direction obtainer 10 obtains direction information of sound source S that is added to a sound signal of content or a sound signal of a participant of a remote call, for instance.

Then, direction obtainer 10 grasps spatial arrangement of sound source S and listener U. This arrangement may be an arrangement in a space including a virtual space, for instance, set in content, as explained above. Then, direction obtainer 10 calculates the direction of sound source S in a view from listener U, that is, a sound-source direction, according to the grasped arrangement in the space. For a sound signal of content also, direction obtainer 10 can similarly calculate a sound-source direction by referring to direction information of the sound signal of sound source S, based on the position of listener U.

Note that direction obtainer 10 may also calculate the direction of listener U in a view from sound source S.

### (Step S102)

Next, panner 20 performs panning processing. Here, panner 20 pans sound source S, using direction information. In the present embodiment, panner 20 performs panning from an aspect as to how close a sound synthesized by panning in an ear can be made to a sound that is originally heard in the ear.

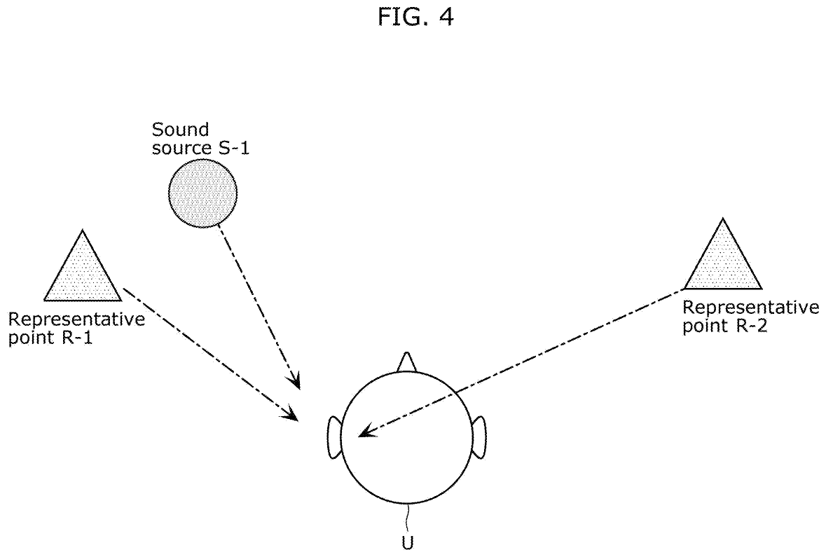

With reference to FIG. 4, computation performed when panner 20 pans sound source S-1 using representative points R-1 and R-2 is to be explained. FIG. 4 illustrates a portion of FIG. 2 for explanation. Here, a signal to be panned is sound source S-1, but yet, calculation is performed using HRIRs from sound source S-1, representative point R-1, and representative point R-2 to an ear to calculate an optimal shift amount and an optimal gain therefor, in the following.

In the example in FIG. 4, an HRIR having P points (taps) of sampling from sound source S-1 to an ear is assumed to be a P-dimensional vector. This is expressed as v{x} (in the embodiments below, a vector is shown as “v{ }”).

Here, panner 20 assumes that an HRIR from representative point R-1 to an ear of listener U is v{x₀₁}, and an HRIR from representative point R-2 to the ear of listener U is v{x₀₂}. A cross-correlation between v{x} and v{x₀₁} is calculated, and a result of applying a time shift to v{x₀₁} to maximize the cross-correlation is assumed to be v{x₁}. Similarly, a cross-correlation between v{x} and v{x₀₂} is calculated, and a result of applying a time shift to v{x₀₂} to maximize the cross-correlation is assumed to be v{x₂}.

Gain A is applied to v{x₁}, gain B is applied to v{x₂}, and v{x} is approximated with a sum of the results. Thus, v{x} is approximated, assuming that an approximate value of v{x}=A×v{x₁}+B×v{x₂}. Accordingly, panning with less error can be performed.

Details of such calculation of gains and time shifts are to be explained. First, calculation of gains is to be explained. An error vector as a consequence of approximation of v{x} is shown by Expression (1) below.

$$\begin{matrix}[ Math 1 ] & \\ \vec{e} = \{ \vec{x} ( A \vec{{x}_{1}} + B \vec{{x}_{2}} ) \} & Expression ( 1 )\end{matrix}$$

Note that in Expression (1) above, the arrows above variables show that the variables are vectors. Here, when A and B have optimal magnitudes, or in other words, when the magnitude of an error vector is minimum, error vector v{e} is orthogonal to a plane defined by vectors v{x₁} and v{x₂} that are used for synthesis. Accordingly, the relations of Expression (2) below are satisfied.

$$\begin{matrix}[ Math 2 ] & \\ \{ \vec{x} - ( A \vec{{x}_{1}} + B \vec{{x}_{2}} ) \} ⊥ \vec{{x}_{1}} \{ \vec{x} - ( A \vec{{x}_{1}} + B \vec{{x}_{2}} ) \} ⊥ \vec{{x}_{2}} & Expression ( 2 )\end{matrix}$$

Accordingly, Expression (3) below is calculated.

$$\begin{matrix}[ Math 3 ] & \\ \{ \vec{x} - ( A \vec{{x}_{1}} + B \vec{{x}_{2}} ) \} \cdot \vec{{x}_{1}} = 0 \{ \vec{x} - ( A \vec{{x}_{1}} + B \vec{{x}_{2}} ) \} \cdot \vec{{x}_{2}} = 0 & Expression ( 3 )\end{matrix}$$

Expression (4) below is obtained by modifying Expression (3).

$$\begin{matrix}[ Math 4 ] & \\ \vec{{x}_{1}} \cdot \vec{x} - A \vert \vec{{x}_{1}} {\vert}^{2} - B \vec{{x}_{1}} \cdot \vec{{x}_{2}} = 0 \vec{{x}_{2}} \cdot \vec{x} - A \vec{{x}_{1}} \cdot \vec{{x}_{2}} - B \vert \vec{{x}_{2}} {\vert}^{2} = 0 & Expression ( 4 )\end{matrix}$$

Expression (5) below is obtained by performing a computation |v{x₂} |² on the upper expression of Expression (4) and a computation v{x₁}·v{x₂} on the lower expression of Expression (4).

$$\begin{matrix}[ Math 5 ] & \\ \vec{{x}_{1}} \cdot \vec{x} \vert \vec{{x}_{2}} {\vert}^{2} - A \vert \vec{{x}_{1}} {\vert}^{2} \vert \vec{{x}_{2}} {\vert}^{2} - B \vec{{x}_{1}} \cdot \vec{{x}_{2}} \vert \vec{{x}_{2}} {\vert}^{2} = 0 \vec{{x}_{2}} \cdot \vec{x} ( \vec{{x}_{1}} \cdot \vec{{x}_{2}} ) - A \vert \vec{{x}_{1}} \cdot \vec{{x}_{2}} {\vert}^{2} - B \vert \vec{{x}_{2}} {\vert}^{2} ( \vec{{x}_{1}} \cdot \vec{{x}_{2}} ) = 0 & Expression ( 5 )\end{matrix}$$

A can be calculated by subtracting the lower expression of Expression (5) from the upper expression thereof and eliminating B. Expression (6) shows this.

$$\begin{matrix}[ Math 6 ] & \\ \vec{{x}_{1}} \cdot \vec{x} \vert \vec{{x}_{2}} {\vert}^{2} - A \vert \vec{{x}_{1}} {\vert}^{2} \vert \vec{{x}_{2}} {\vert}^{2} - \{ \vec{{x}_{2}} \cdot \vec{x} ( \vec{{x}_{1}} \cdot \vec{{x}_{2}} ) - A \vert \vec{{x}_{1}} \cdot \vec{{x}_{2}} {\vert}^{2} ] = 0 - A ( \vert \vec{{x}_{1}} {\vert}^{2} \vert \vec{{x}_{2}} {\vert}^{2} - \vert \vec{{x}_{1}} \cdot \vec{{x}_{2}} {\vert}^{2} ) = - \vec{{x}_{1}} \cdot \vec{x} \vert \vec{{x}_{2}} {\vert}^{2} + \vec{{x}_{2}} \cdot \vec{x} ( \vec{{x}_{1}} \cdot \vec{{x}_{2}} ) & Expression ( 6 )\end{matrix}$$

Accordingly, gain A is as shown by Expression (7) below.

$$\begin{matrix}[ Math 7 ] & \\ A = \frac{\vec{{x}_{1}} \cdot \vec{x} {\vert \vec{{x}_{2}} \vert}^{2} - \vec{{x}_{2}} \cdot \vec{x} ( \vec{{x}_{1}} \cdot \vec{{x}_{2}} )}{{\vert \vec{{x}_{1}} \vert}^{2} {\vert \vec{{x}_{2}} \vert}^{2} - {\vert \vec{{x}_{1}} \cdot \vec{{x}_{2}} \vert}^{2}} & Expression ( 7 )\end{matrix}$$

Similarly, by eliminating gain A, gain B can be calculated as shown by Expression (8) below.

$$\begin{matrix}[ Math 8 ] & \\ B = \frac{\vec{{x}_{2}} \cdot \vec{x} \vert \vec{{x}_{1}} {\vert}^{2} - \vec{{x}_{1}} \cdot \vec{x} ( \vec{{x}_{1}} \cdot \vec{{x}_{2}} )}{\vert \vec{{x}_{1}} {\vert}^{2} \vert \vec{{x}_{2}} {\vert}^{2} - \vert \vec{{x}_{1}} \cdot \vec{{x}_{2}} {\vert}^{2}} & Expression ( 8 )\end{matrix}$$

Accordingly, gains A and B are determined to cause an error vector between a synthesized signal and a target signal to be orthogonal to a representative direction vector used.

Gains A and B obtained by this calculation are applied to an HRIR waveform of v{x₁} and an HRIR waveform of v{x₂} to each of which a time shift based on a cross-correlation has been applied, and an HRIR that is to be output can be synthesized. Thus, the amounts of time shifts (time shift values) and gains A and B are applied to sound source S-1, and panning is performed.

Next, specific processing for computing time shifts that maximize a cross-correlation is to be explained. In the present embodiment, for v{x} and v{x₀₁}, an HRIR having P sampling points is treated as a vector. Accordingly, it is possible to explicitly state subscripts indicating time of an HRIR (the position of a sampling point) as shown by Expression (9) below.

$$\begin{matrix}[ Math 9 ] & \\ \vec{x} = ( x ( 0 ) , x ( 1 ) , x ( 2 ) , , , x ( P - 1 ) ) & Expression ( 9 )\end{matrix}$$

$$\vec{{x}_{01}} = ( {x}_{01} ( 0 ) , {x}_{01} ( 1 ) , {x}_{01} ( 2 ) , , , , {x}_{01} ( P - 1 ) )$$

Then, a cross-correlation of two vectors in Expression (9) is expressed as a function of “k”, and is defined as shown by Expression (10) below.

$$\begin{matrix}[ Math 10 ] & \\ {ϕ}_{x {x}_{01}} ( k ) = \frac{1}{P - k} {\sum }_{n = 0}^{P - 1 - k} x ( n ) {x}_{01} ( n + k ) ( 0 \leq k \leq P - 1 ) & Expression ( 10 )\end{matrix}$$

$${ϕ}_{x {x}_{01}} ( k ) = \frac{1}{P + k} {\sum }_{n = - k}^{P - 1} x ( n ) {x}_{01} ( n + k ) ( - P + 1 \leq k < 0 )$$

Here, k that gives a maximum value of φₓₓ₀₁(k) is stated as kₘₐₓ₀₁. Panner 20 calculates kₘₐₓ₀₁ by substituting values for k, for example. Similarly, k that gives a maximum value of φₓₓ₀₂(k) is stated as kₘₐₓ₀₂. Panner 20 calculates kₘₐₓ₀₂ similarly to kₘₐₓ₀₁. Any one of kₘₐₓ₀₁ or kₘₐₓ₀₂ is simply stated as “kₘₐₓ” in the following. Panner 20 stores, in HRIR table 200, gains A and B as gain values and kₘₐₓ₀₁ and kₘₐₓ₀₂ as time shift values, which are calculated for different sound-source directions of sound sources S at 2-degree intervals out of 360-degree full circumference, and use the values in the output processing stated below, for example. Note that using HRIR table 200 that stores therein precalculated values of gains A and B and kₘₐₓ₀₁ and kₘₐₓ₀₂ denoting time shifts, only the sound output processing as below can be performed.

### (Step S103)

Next, panner 20 and outputter 30 perform sound output processing. First, panner 20 obtains, for each of sound sources S, a gain value and a time shift value for the obtained sound-source direction, from HRIR table 200. Then, panner 20 applies the gain value to each sampling point (sample) of the waveform of sound source S.

At this time, panner 20 may correct the gain to maintain an energy balance between HRIRs of left and right ears based on sound source S, with use of an HRIR synthesized by panning. Thus, an adjustment coefficient may be applied to each gain value, to cause the energy balance between the left and right HRIRs to coincide with an original HRIR.

Next, panner 20 applies a time shift to a signal to which the gain value has been applied.

Details of such a time shift are to be explained. Vector v{x₁} resulting from shifting an element of vector v{x₀₁} by kₘₐₓ samples is generated by the following procedure.

First, when a phase is proceeded, or stated differently, in the case of kₘₐₓ≥0, zero is set at the end of a vector for the kₘₐₓ samples, and the length of the vector is maintained. On the other hand, when a phase is delayed, or stated differently, in the case of kₘₐₓ<0, zero is set at the start of a vector for the kₘₐₓ samples, and the length of the vector is maintained. Accordingly, settings are applied as shown by Expression (11) below.

$$[ Math 11 ]$$

$$In the case of {k}_{max} \geq 0 , \vec{{x}_{1}} = ( {x}_{01} ( 0 + {k}_{max} ) , {x}_{01} ( 1 + {k}_{max} ) , {x}_{01} ( 2 + {k}_{max} ) , … {x}_{01} ( P - 1 ) , … 0 , 0 , 0 ) \qquad Expression ( 11 )$$

$$In the case of {k}_{max} < 0 , \vec{{x}_{1}} = ( 0 , 0 , 0 , … {x}_{01} ( 0 ) , {x}_{01} ( 1 ) , {x}_{01} ( 2 ) , … {x}_{01} ( P - 1 + {k}_{max} ) )$$

Time-shifted vector v{x₁} is generated in this manner. The positive or negative polarity of the value of a time shift amount is inverted according to which one is applied as a reference when the cross-correlation is calculated. When convolving a sound source signal of an HRIR, the polarity of the time shift amount needs to be paid attention.

Note that panner 20 can apply, as such a time shift, a decimal shift by a decimal factor by oversampling, rather than an integer multiple of the tap count, as shown by Examples explained later. Alternatively, a gain value may be applied after applying a time shift.

Panner 20 treats a thus-calculated signal to which a gain and a time shift have been applied, as a representative-point signal present at a position of representative point R. Then, panner 20 generates a sum signal by obtaining a sum of representative-point signals of sound sources S integrated at representative point R.

Panner 20 generates a signal that reaches an ear of listener U by convolving the sum signal with an HRIR at the position of representative point R (an HRIR in the representative point direction).

Outputter 30 outputs the signal that reaches an ear generated by panner 20 to reproducer 40 to have the signal reproduced. The output may be a two-channel analog sound signal for the left ear and the right ear of listener U, for example.

Accordingly, reproducer 40 can reproduce a sound signal corresponding to a virtual sound field, as a two-channel sound signal reproduced by headphones. Through the above, the sound reproduction processing according to Embodiment 1 ends.

The configuration as above yields effects as follows.

Recently, when content such as movies, AR, VR, MR, and games is reproduced by VR headphones or HMDs, rendering technology (binaural technology) for appropriately describing and reproducing the entire three-dimensional (3D) sound field has been required. Conventionally, a 3D stereophonic sound (binaural signal) has been generated by convolving sound source signals each with an HRIR in the corresponding sound-source direction. In this manner, if sound sources S are each convolved with an HRIR, an enormous amount of computation is required in order to track movement of a person (6DoF: six degrees of freedom) with a high sense of presence, which has been a problem.

On the other hand, in panning using loudspeakers, conventionally, sound images have been generated between the loudspeakers by controlling the volume balance between the loudspeakers in accordance with the sine law, the tangent law, or the like. However, a stereophonic sound image could not have appropriately reproduced using headphones by merely controlling the volume balance.

To address this, sound generation device 2 according to Representative Example (A) includes: direction obtainer 10 that obtains a sound-source direction of sound source S; and panner 20 that expresses sound source S, by applying a time shift and gain adjustment to sound source S to perform panning using a sound in a particular representative direction, based on the sound-source direction obtained by direction obtainer 10.

With such a configuration, sound source S is synthesized by panning in a representative direction, and the number of sound-source directions is decreased, thus achieving efficient and effective rendering. Accordingly, the amount of computation can be reduced as compared with a conventional technique of individually convolving signals of sound sources S with HRIRs. Thus, panner 20 can equivalently synthesize, by panning, an HRIR in a representative direction similar to a sound-source direction obtained by direction obtainer 10, and generate an HRIR in the sound-source direction. By reducing the amount of computation in this manner, sound generation device 2 is applicable to VR and AR apps for games and videos, for instance, as a 3D sound field reproduction system. By applying sound generation device 2 to smartphones and home electric appliances, the amount of computation for generating a stereophonic sound, and cost can be reduced. Furthermore, sound generation device 2 is applicable to international standardization, for instance, as a method with which the amount of computation is reduced more.

Sound generation device 2 according to Representative Example (B) is sound generation device 2 according to Representative Example (A), in which a plurality of sound sources S are present, the plurality of sound sources S each being sound source S, a plurality of particular representative directions are directions for a plurality of representative points that are less in number than the plurality of sound sources S, the particular representative directions each being the particular representative direction, and panner 20 synthesizes a sound image of the plurality of sound sources S by using sounds in the plurality of particular representative directions.

With such a configuration, sound sources S in the sound-source directions are panned into predetermined representative directions, examples of which are two to six directions surrounding listener U, and sound sources S are integrated in such directions and then convolved with HRIRs. Accordingly, the amount of computation can be reduced as compared with the conventional technique of convolving sound source signals individually with HRIRS.

Sound generation device 2 according to Representative Example (C) is sound generation device 2 according to Representative Example (A) or (B), in which panner 20 applies, to the plurality of sound sources S, time shifts calculated to maximize a cross-correlation between HRIRs in sound-source directions of the plurality of sound sources and HRIRs in the plurality of particular representative directions, or minus-sign time shifts resulting from assigning a minus sign to the time shifts.

With this configuration, panner 20 calculates a time shift amount (a time shift value) for each sound-source direction, to maximize the cross-correlation between HRIRs in the sound-source directions and HRIRs in the representative directions, applies the time shift amounts (the time shift values) to sound source signals and further multiplies appropriate gains, to assign the sound source signals to each representative direction. Accordingly, when panning is performed, a signal of sound source S is time-shifted, distortion of an HRIR virtually synthesized with a sound being emitted in the representative direction is reduced, and a signal resulting from convolving an HRIR equivalent to a targeted HRIR with sound source S can be generated. Thus, a sound that reaches an ear, which is synthesized by applying a time shift to and panning sound source S, can be made closer to a sound that reaches the ear, which is generated by convolving sound sources with original HRIRs.

Sound generation device 2 according to Representative Example (D) is sound generation device 2 according to any one of Representative Examples (A) through (C), in which in the time shifts, a shift by a decimal of sampling is permitted.

With such a configuration, panning with which distortion is further reduced can be performed. Thus, as shown by Examples explained later, a signal-noise ratio (S/N ratio, hereinafter referred to as “SNR”) can be improved while reducing a change in the comb shape of the SNR due to an integer shift.

Sound generation device 2 according to Representative Example (E) is sound generation device 2 according to any of Representative Examples (A) through (D), in which for each of the plurality of representative points, panner 20 applies a gain to each of the plurality of sound sources S to which the time shifts have been applied, the gain being set for sound source S and the particular representative direction for the representative point.

With such a configuration, a gain set for each of sound sources S is applied to each of representative points R, and a sum of signals resulting from applying such set gains to all sound sources S is calculated. Thus, panner 20 convolves HRIRs in the representative directions with the calculated sum of results obtained by applying gains to sound sources S that are time-shifted, to equivalently synthesize signals resulting from convolving HRIRs in the sound-source directions with sound sources S. Accordingly, a stereophonic sound using HRIRs can be reproduced while distortion is minimized in panning and the amount of computation is reduced.

Sound generation device 2 according to Representative Example (F) is sound generation device 2 according to any one of Representative Examples (A) through (E), in which when an HRIR (vector) in one of the plurality of sound-source directions is synthesized by using a sum of HRIRs (vectors) in the plurality of representative directions to obtain a synthesized HRIR (vector), panner 20 uses the gain calculated to cause an error signal vector between the synthesized HRIR (vector) and the HRIR (vector) in the one of the sound-source directions to be orthogonal to each of the HRIRs (vectors) in the plurality of representative directions.

With such a configuration, when an HRIR (a vector) in a sound-source direction is synthesized with use of a sum of HRIRs (vectors) in representative directions to obtain a synthesized HRIR (vector), the gain is calculated to cause an error signal vector between the synthesized HRIR (vector) and the HRIR (vector) in the sound-source direction to be orthogonal to each of the HRIRs in the representative directions. Thus, a gain that causes an equivalently synthesized HRIR to be in a shape most similar to an original HRIR is calculated, and panning is performed. Accordingly, panning with minimized distortion can theoretically be performed. Thus, while saving computation resources, panning that is suitable to listening to, for instance, AR/VR through headphones more accurately than in accordance with the sine law, the tangent law, or the like.

Sound generation device 2 according to Representative Example (G) is sound generation device 2 according to any one of Representative Examples (A) through (F), in which panner 20 uses the gain corrected to maintain an energy balance between HRIRs of left and right ears from a position of one of the plurality of sound sources S, in HRIRs resulting from substantially synthesizing, by panning, HRIRs from the plurality of representative points.

With such a configuration, an energy balance can be prevented from being made unnatural by synthesizing HRIRs.

Sound generation device 2 according to Representative Example (H) is sound generation device 2 according to any one of Representative Examples (A) through (G), in which panner 20 applies the time shifts to the plurality of sound sources S, treats signals to each of which the gain has been applied, as representative-point signals present at positions of the plurality of representative points, and convolves HRIRs at the positions of the plurality of representative points with a sum signal of the representative-point signals equal in number to the plurality of sound sources S, to generate a signal that reaches an ear of listener U.

With such a configuration, high-quality stereophonic sound signals can be generated while an amount of computation is reduced. Furthermore, gain values and time shift values are calculated and stored in HRIR table 200, such values are applied to sound sources S and a sum signal is calculated, and the sum signal is convolved with an HRIR at a position of a representative point, and a stereophonic sound can be reproduced. This computation load can be remarkably reduced as the number of sound sources S is greater, as shown in Examples explained later. Specifically, even the number of sound sources S is 3 to 4, the number of product-sum operations can be reduced to 65% to 80%.

Sound generation device 2 according to Representative Example (I) is sound generation device 2 according to any one of Representative Examples (A) through (H), in which sound source S is a sound signal of content or a sound signal of a participant of a remote call, and direction obtainer 10 obtains a direction of listener U relative to an emission direction of a sound based on sound source S.

With such a configuration, a sound can be generated for many sound sources S when content is reproduced in Messenger in which one-to-one connection, one-to-multipoint connection, or multipoint-to-multipoint connection is established or a remote conference, for instance, while the load is reduced.

Sound reproduction device 1 according to Representative Example (J) includes sound generation device 2 according to any one of (A) through (I), and sound outputter 30 that outputs a sound signal generated by sound generation device 2.

With such a configuration, a generated sound can be output through headphones or an HMD, for instance, and a listener can perceive the sound with sense of presence.

Note that the embodiments explained above have shown a case where panner 20 expresses sound source signals by panning based on representative points in two directions of left and right, that is, an example in which panner 20 equivalently synthesizes HRIR vectors in the sound-source directions using HRIR vectors in the left-right directions. Thus, the above embodiments have shown a case where directions of left and right angles relative to listener U are considered as direction information.

However, as such arrival directions, up-and-down directions can also be considered. Specifically, HRIR vectors in sound-source directions can be equivalently synthesized by interpolation using HRIR vectors in three directions. Thus, panner 20 can similarly execute panning processing using representative points in three directions that include an elevation angle direction.

In this case, similarly to interpolation in two directions, results obtained by applying a time shift to each HRIR in the representative directions to maximize a cross-correlation with v{x} are v{x₁}, v{x₂}, and v{x₃} in vector notation. In this case, error vector v{e} is shown by Expression (12) below.

$$\begin{matrix}[ Math 12 ] & \\ \vec{e} = \{ \vec{x} - ( A \vec{{x}_{1}} + B \vec{{x}_{2}} + C \vec{{x}_{3}} ) \} & Expression ( 12 )\end{matrix}$$

This is applied to Expression (13) below and solved.

$$[ Math 13 ]$$

$$\frac{\partial {\vert \vec{e} \vert}^{2}}{\partial A} = 0 \frac{\partial {\vert \vec{e} \vert}^{2}}{\partial B} = 0 \frac{\partial {\vert \vec{e} \vert}^{2}}{\partial C} = 0 \qquad Expression ( 13 )$$

Specifically, optimal gains A, B, and C can be calculated using Expression (14) below.

$$[ Math 14 ]$$

$$[ \begin{matrix}A \\ B \\ C\end{matrix} ] = {[ \begin{matrix}{\vert \vec{{x}_{1}} \vert}^{2} & \vec{{x}_{1}} \cdot \vec{{x}_{2}} & \vec{{x}_{1}} \cdot \vec{{x}_{3}} \\ \vec{{x}_{1}} \cdot \vec{{x}_{2}} & {\vert \vec{{x}_{2}} \vert}^{2} & \vec{{x}_{2}} \cdot \vec{{x}_{3}} \\ \vec{{x}_{1}} \cdot \vec{{x}_{3}} & \vec{{x}_{2}} \cdot \vec{{x}_{3}} & {\vert \vec{{x}_{3}} \vert}^{2}\end{matrix} ]}^{- 1} [ \begin{matrix}\vec{{x}_{1}} \cdot \vec{x} \\ \vec{{x}_{2}} \cdot \vec{x} \\ \vec{{x}_{3}} \cdot \vec{x}\end{matrix} ] \qquad Expression ( 14 )$$

Here, “−1” on the right shoulder of the matrix in Expression (14) stated above means an inverse matrix. Time shift amounts kₘₐₓ₀₁, kₘₐₓ₀₂, and kₘₐₓ₀₃ of the HRIRs in the representative directions determined to maximize the cross-correlation are also calculated prior to the gain values stated above, similarly to the values in the case of two directions.

In the above embodiments, an example in which two to four representative points R are used is explained.

However, more than two representative points R can of course be used. For example, four to six representative points R corresponding to range angles of 90 degrees and 60 degrees, for instance, can be used as shown by Examples explained later. Furthermore, also in the case of four representative points R, different positions of representative points R can be set such as positions oblique to listener U (45 degrees, 135 degrees, 225 degrees, and 315 degrees), or vertical and horizontal positions (0 degrees, 90 degrees, 180 degrees, and 270 degrees). Two or three points closest to a sound-source direction can be selected from among four to six representative points R, and used as representative points R for synthesizing the sound source.

Specifically, sound generation device 2 according to Representative Example (K) is sound generation device 2 according to any one of Representative Examples (A) through (H), in which panner 20 uses the gain calculated to minimize an L2 norm or energy of an error signal vector between a synthesized HRIR vector and an HRIR vector in one of the plurality of sound-source directions.

Sound reproduction device 1 according to Representative Example (L) may include sound generation device 2 according to Representative Example (K), and sound outputter 30 that outputs a sound signal generated by sound generation device 2.

With such a configuration, an HRIR vector in a sound-source direction can be equivalently synthesized by interpolation using HRIR vectors in the three directions.

### Embodiment 2

(Weighting Filter Applied when Calculating Time Shift and Gain)

Embodiment 1 explained above has shown an example in which an HRIR itself is used when a time shift and a gain that maximize a cross-correlation are calculated. However, in a sound generation device according to Embodiment 2, a result obtained by calculating the cross-correlation after applying a weighting filter on a frequency axis may be used for the time shifts, gains, or the time shifts and gains. Specifically, when a time shift and a gain that maximize a cross-correlation are calculated, a result obtained by applying a weighting filter on a frequency axis (hereinafter, also referred to as “frequency weighting filter”) can be used.

As such a frequency weighting filter, it is suitable to use a filter that attenuates a range higher than the cut-off frequency, that is, a range in which humans have low audibility, when the cut-off frequency is a frequency in the vicinity of or slightly higher than a frequency range in which humans have high audibility. For example, it is suitable to use a low-pass filter (LPF) having a cut-off frequency of 3000 Hz to 6000 Hz and an attenuation slope of 6 dB/Oct (octave) to 12 dB/Oct.

Specifically, v{x} and v{x₀₁} treat HRIRs at P points as vectors, and thus can be expressed as Expression (9) explained above by explicitly stating subscripts of time of the HRIRs. Here, a result of convolving the two vectors in Expression (9) above with impulse response w_{c}(n) of a frequency weighting filter and cutting the length at P is shown by Expression (15) below.

$$[ Math 15 ]$$

$${x}_{w} ( n ) = x ( n ) * {w}_{c} ( n ) , {x}_{01 w} ( n ) = {x}_{01} ( n ) * {w}_{c} ( n ) \qquad Expression ( 15 )$$

Here, computation “*” indicates convolution. Then, the cross-correlation of two vectors of Expression (15) is assumed to be a function of “k”, and is defined as shown by Expression (16) as below.

$$[ Math 16 ]$$

$${ϕ}_{{xx}_{01}} ( k ) = \frac{1}{P - k} {\sum }_{n = 0}^{P - 1 - k} {x}_{w} ( n ) {x}_{01 w} ( n + k ) ( 0 \leq k \leq P - 1 ) \qquad Expression ( 16 )$$

$${ϕ}_{{xx}_{01}} ( k ) = \frac{1}{P + k} {\sum }_{n = - k}^{P - 1} {x}_{w} ( n ) {x}_{01 w} ( n + k ) ( - P + 1 \leq k < 0 )$$

Here, k that gives a maximum value of φₓₓ₀₁(k) based on Expression (16) is stated as kₘₐₓ. Panner 20 generates vector v{x₁} resulting from shifting elements of vector v{x₀₁} by kₘₐₓ samples by the following procedure, similarly to Expression (11) stated above.

Specifically, when the phase is proceeded, or stated differently, in the case of kₘₐₓ≥0, the length of the vector is maintained by padding zero at the end of the vector for the kₘₐₓ samples. Thus, in the case of kₘₐₓ≥0, vector v{x₁} is v{x₁}=(x₀₁(0+kₘₐₓ), x₀₁(1+kₘₐₓ), x₀₁(2+kₘₐₓ), . . . x₀₁(P−1), . . . 0, 0, 0).

On the other hand, when the phase is delayed, or stated differently, in the case of kₘₐₓ<0, the length of the vector is maintained by padding zero at the start of a vector for the kₘₐₓ samples. Thus, in the case of kₘₐₓ<0, vector v{x₁} is v{x₁}=(0, 0, 0, . . . , x₀₁(0), x₀₁(1), x₀₁(2), . . . , x₀₁(P−1+kₘₐₓ)).

In the above, vector v{x_{01w}} may be used as vector v{x₀₁}. In this manner, vector v{x₁} can be generated. Thus, similarly to Embodiment 1 above, a cross-correlation can be calculated and used to calculate a time shift.

(Weighting Filter Used when Calculating Error)

In Embodiment 1 above, when an error (similarity) between a synthesized HRIR and an original HRIR is calculated, A, B, and C that minimize |v{e}|² of an error signal vector (error vector) v{e} are calculated as shown by Expression (12) above.

With regard to this, in the present embodiment, a result obtained by applying a frequency weighting filter may be used for v{e}. Specifically, when v{e} is a waveform data on a time axis, v{e_{w}} is shown by Expression (17) below, where v{e_{w}} is a result obtained by convolving impulse response w(n) of the weighting filter with v{e}.

$$[ Math 17 ]$$

$${\vec{e}}_{w} = \{ \vec{x} - ( A \vec{{x}_{1}} + B \vec{{x}_{2}} + C \vec{{x}_{3}} ) \} * \vec{w} \qquad Expression ( 17 )$$

Here, \vec{e} is a vector notation of impulse response w(n).

Computation “*” indicates convolution. Here, operator “*” is used for a vector, and it is a vector notation of a numerical sequence obtained as a result of convolving vectors on the right and left of the operator represented as numerical sequences. Thus, v{x} *v{y} is a vector notation of the result of x(n)*y(n). In the following, if no designation is given in particular, operator “*” for a vector is treated in the same manner.

Then, v{e_{w}} is applied to Expression (18) below and Expression (18) is solved, so that gains A, B, and C can be calculated.

$$[ Math 18 ]$$

$$\frac{\partial {\vert {\vec{e}}_{w} \vert}^{2}}{\partial A} = 0 \frac{\partial {\vert {\vec{e}}_{w} \vert}^{2}}{\partial B} = 0 \frac{\partial {\vert {\vec{e}}_{w} \vert}^{2}}{\partial C} = 0 \qquad Expression ( 18 )$$

Accordingly, v{e}_{w} can be equivalently calculated by Expression (19) below.

$$[ Math 19 ]$$

$${\vec{e}}_{w} = \{ \vec{x} * \vec{w} - ( A \vec{{x}_{1}} * \vec{w} + B \vec{{x}_{2}} * \vec{w} + C \vec{{x}_{3}} * \vec{w} ) \} \qquad Expression ( 19 )$$

Here, \vec{w} is a vector notation of impulse response w(n).

Using time shifts and gains obtained in this manner, target signals can be divided (panned) among representative directions.

Note that a target signal that is panned and an HRIR that is convolved may be similar to those in Embodiment 1 explained above. Thus, a weighting filter may not be convolved with a target signal or an HRIR that is convolved.

By introducing such frequency weighting, an error is further reduced (accuracy is increased), and a frequency band in which approximation is performed can be set. In particular, main energy of music and sound signals is concentrated in a low-frequency region, and thus favorable performance can be achieved by using a weighting filter for weighting a low frequency side.

When convolution of a weighting filter having an impulse response of w(n) and a vector is expressed by convolution matrix W having rows of results each obtained by applying a time shift to impulse response w(n) by one sample, Expression (17) can be modified as Expression (20) below.

$$[ Math 20 ]$$

$${\vec{e}}_{w} = W \{ \vec{x} - ( A \vec{{x}_{1}} + B \vec{{x}_{2}} + C \vec{{x}_{3}} ) \} \qquad Expression ( 20 )$$

Then, |v{e} |² can be calculated by Expression (21) below.

$$[ Math 21 ]$$

$$\begin{matrix}{\vert {\vec{e}}_{w} \vert}^{2} & = {\vec{e}}_{w}^{T} {\vec{e}}_{w} \\ & = {\{ W \{ \vec{x} - ( A \vec{{x}_{1}} + B \vec{{x}_{2}} + C \vec{{x}_{3}} ) \} \}}^{T} W \{ \vec{x} - ( A \vec{{x}_{1}} + B \vec{{x}_{2}} + C \vec{{x}_{3}} ) \} \\ & = {\{ \vec{x} - ( A \vec{{x}_{1}} + B \vec{{x}_{2}} + C \vec{{x}_{3}} ) \}}^{T} {W}^{T} W \{ \vec{x} - ( A \vec{{x}_{1}} + B \vec{{x}_{2}} + C \vec{{x}_{3}} ) \}\end{matrix} \qquad Expression ( 21 )$$

Here, W^{T} denotes a transposed matrix of W.

A weighting filter used for calculating a cross-correlation and a weighting filter used for calculating a gain may have the same property or different properties. When the filters having the same properties are used, weighting filter w may be convolved with the entire set of original HRIRs, and thereafter time shift amounts and gains may be calculated by performing processing similar to that in Embodiment 1 explained above.

Note that when a weight is given using an LPF to a low frequency region as a weighting filter explained above and a cross-correlation and an optimal gain are calculated, a decimal shift may not be applied in Embodiment 1 above when an effective band is limited to about 3000 Hz. In this case, oversampling is also not necessary.

### (High Frequency Emphasis Filter)

In the above embodiment, sound signals are panned and distributed to a plurality of representative directions, convolved with HRIRs in the representative directions, and expressed. Specifically, in Embodiment 1 and Embodiment 2 explained above, an HRIR in a target direction is imitated using a sum of HRIRs in representative directions, as an approximate value of v{x} in three directions=A×v{x₁}+B×v{x₂}+C×v{x₃}.

In this case, an amplitude property of a high frequency region of an HRIR tends to have a level lower than the level of an original HRIR, as compared with an amplitude property of a low frequency region. This is because even with a minor error of time due to a slight shift in position of a listening point, the phase of a high-frequency component of the HRIR tends to greatly rotate and to be cancelled out by the addition by panning.

To address this, in the sound generation device according to the present embodiment, a reproduction high-frequency emphasis filter may compensate a tendency for a high-frequency range to attenuate.

Specifically, the tendency for a high-frequency range to attenuate can be compensated by applying a high-frequency emphasis filter to a signal convolved with an HRIR in a representative direction by panning. Or equivalently, high-frequency emphasis filter processing may be applied in advance to the HRIR in the representative direction itself, and a high-frequency range may be emphasized. The high-frequency emphasis filter may be an impulse-response weighting filter that emphasizes a high-frequency range by approximately +1 dB to +1.5 dB, with a turnover frequency of at least 5000 Hz to 15000 Hz, for example.

In this manner, stereophonic effect for auditory sensation can be further enhanced by performing filter processing for emphasizing a high frequency range of a sound synthesized using panning.

Note that also in the case where a decimal shift is applied similarly to Embodiment 1 explained above, in normal 8 to 16 times oversampling, mismatch of high-frequency components of an HRIR remains, and thus a high-frequency emphasis filter may be applied.

### Other Embodiments

Although the above embodiments have stated that a sound signal of sound source S is convolved with an HRIR, similar processing can be performed by converting a sound signal of sound source S into a frequency region and applying an HRTF. In this case, a different HRTF may be applied for each frequency region. Specifically, similarly to Embodiment 2 explained above, further accurate synthesis can be performed by using HRTFs in a low frequency range and a high frequency range with reference to a frequency in the vicinity of a frequency band in which human audibility is high or a frequency slightly higher than the frequency band.

In addition, panner 20 may be able to select, from HRIR table 200, an HRIR of an individual user or an HRIR generated using an HRIR database, for instance. Furthermore, when a speaker and listener U are transformed into, for instance, avatars in a virtual space, panner 20 can also select an HRIR from HRIR table 200 according thereto. Specifically, for example, when an avatar has a shape with ears attached to an upper part such as a cat or rabbit, an HRIR that expresses the way of hearing according thereto can be selected.

Furthermore, panner 20 can further enhance sense of reality, by separately overlapping a direct sound of sound source S and a reflected sound by an environment through convolution, for instance. With such a configuration, a clear reproduction sound closer to reality can be reproduced.

In addition, the embodiments above have explained an example of reproducing sounds using left and right two channels as reproducer 40. With regard to this, sounds can be reproduced using, for instance, headphones that can reproduce sounds using multiple channels.

In the above embodiments, sound reproduction device 1 is stated as being integrally configured.

However, sound reproduction device 1 may be configured as a reproduction system to which an information processing device such as a smartphone, a personal computer (PC), or a home electric appliance, and a terminal device set such as a headset, headphones, or left and right separated type earphones are connected. With such a configuration, direction obtainer 10 and reproducer 40 may be included in the terminal device set, and the functions of direction obtainer 10 and panner 20 may be executed by either the information processing device or the terminal device set. In addition, for example, Bluetooth (registered trademark), HDMI (registered trademark), WiFi (registered trademark), Universal Serial Bus (USB), or other wired or wireless information transfer means may allow transfer between the information processing device and the terminal device set. In this case, the functions of the information processing device can be executed by, for instance, a server on an intranet or the Internet.

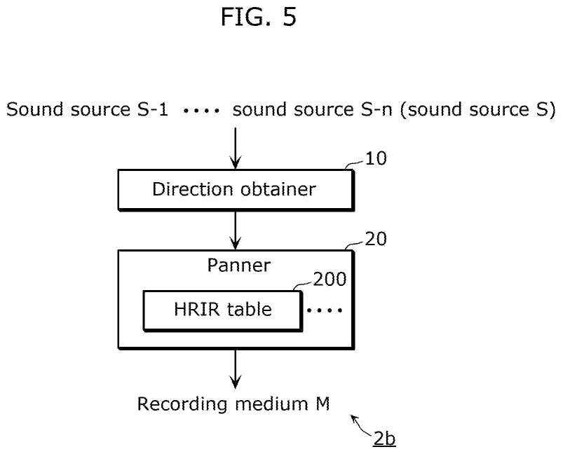

Embodiments 1 and 2 explained above have stated a configuration in which outputter 30 and reproducer 40 are included as sound reproduction device 1. However, a configuration in which outputter 30 and reproducer 40 are not included is also possible. FIG. 5 illustrates an example of a configuration of sound generation device 2b that just generates such sound signals. In sound generation device 2b, for example, data of generated sound signals can be stored in recording medium M.

Sound generation device 2b according to such another embodiment can be used, being provided in various devices such as a PC, a smartphone, a game device, a content reproduction device such as a media player, VR, AR, MR, a video phone, a TV conference system, a remote conference system, a game device, and other home electric appliances. Thus, sound generation device 2b is applicable to all devices that can obtain the direction of sound source S in a virtual space, such as a TV, a device that includes a display, a TV phone via a display, a video conference, or telepresence.

A sound signal processing program according to the present embodiment can be executed by such devices. Furthermore, when content is created or distributed, a PC or a server, for instance, that produces or distributes the content can execute such a sound signal processing program. Sound reproduction device 1 according to the embodiments explained above may be able to execute the sound signal processing program.

Thus, through processing performed by sound generation devices 2 and 2b and/or according to the sound signal processing program, a movie, a game, VR, AR, and MR, for instance, can be reproduced with a higher sense of presence and higher reality by using headphones and/or an HMD. In a remote conference, for instance, a sense of presence can be enhanced. The devices and the program can be applied to movie theaters, field games, capture of three-dimensional (3D) sound fields, transfer, reproduction systems, AR applications, and VR applications, for instance.

In Embodiments 1 and 2 above, an example in which direction information is added to a sound signal of sound source S has been explained. With regard to this, direction information may not be added to a sound signal of sound source S in a situation in which a speaker and a listener are switched at all times, such as in a remote conference stated above. Thus, the direction of a speaker (the current listener) can be estimated using a sound signal output by a speaker when a current listener was the speaker, and can be used as the direction of the listener in a view from the current speaker.

In this case, direction obtainer 10 calculates an arrival direction in a view from listener U of a sound signal, in which an L (left) channel signal (hereinafter, referred to as an “L signal”) and an R (right) channel signal (hereinafter, referred to as an “R signal”) of the sound signal arrive, for example. At this time, direction obtainer 10 may obtain a ratio of intensities between the L channel and the R channel. From the ratio of the intensities, arrival directions of signals having frequency components can be estimated.

Direction obtainer 10 may estimate the arrival directions of sound signals, from relations between interaural time differences (ITD) of signals having frequencies in head-related transfer functions (HRTF) and arrival directions. Direction obtainer 10 may refer to relations stored in a storage serving as a database, for a relation between an ITD and an arrival direction.

By performing face recognition on, for instance, a caller or a listener in content or a video conference from image data of human faces, the directions of the caller and the listener can be estimated. Thus, a direction can be estimated, even with a configuration that does not have head tracking. Similarly, the positions of a speaker and a listener in a space may be able to be grasped.

By having such configurations, various types of flexible configurations can be handled. In usages such as VR and Social VR, the position of a sound source is known in advance, and thus the direction of sound source S can be obtained from a positional relation between sound source S and listener U without estimating the sound-source direction.

Next, based on the drawings, the sound generation device is to be further explained using Examples, but the specific examples below are not intended to limit the sound generation device.

### Example 1

### (Comparison of SNRs Using HRTFs of Person Himself/Herself)

In this experiment, HRIRs were created by converting HRTFs of a subject (listener) himself/herself (hereinafter, referred to as “originals”) actually created for 15-degree intervals. For the HRIRs of the originals, time shifts were applied on the perimeter of the horizontal plane (the lateral direction), using time shift values based on a cross-correlation according to the embodiments explained above, and panning using two representative points was performed using gain values calculated by the vector calculation explained above (hereinafter, referred to as “panning in this Example”).

Specifically, an experiment of comparing a result obtained by convolving sound source S with an HRIR of an original (hereinafter, referred to as a “true value”) with a total (hereinafter, referred to as an “approximate value”) of results obtained by convolving results of the panning in this Example with the HRIRs at the two representative points was conducted. Note that in fact, in order to simplify the processing procedure, results obtained by applying gains to results obtained by applying time shifts to the HRIRs at the two representative points were added up to obtain a sum that indicates an imitated HRIR in a sound-source direction (hereinafter, referred to as “synthesized HRIR”), and the synthesized HRIR is convolved with a sound source signal, to generate a signal equivalent to the above “approximate value”.

Furthermore, a gain according to a conventional sine law without a conventional time shift was used, as a comparative example. In the sine law according to the comparative example, when θ denotes an angle between the front and sound source S and θ₀ denotes an angle to representative point R, left and right gains Aₛ and Bₛ with which a sound source signal convolved with HRIRs for which two representative points were used was multiplied were calculated by (Aₛ−Bₛ)/(Aₛ+Bₛ)=sin θ/sin θ₀.

Representative points used in this Example were set in representative point directions defined by (1) a range angle of 90 degrees (45 degrees, 135 degrees, 225 degrees, and 315 degrees), (2) a range angle of 90 degrees (0 degrees, 90 degrees, 180 degrees, and 270 degrees), and (3) a range angle of 60 degrees (30 degrees, 90 degrees, 150 degrees, 210 degrees, 270 degrees, and 330 degrees). The sets of the representative points are referred to as (1) four directions_oblique, (2) four directions_vertical/horizontal, and (3) six directions. For Example and the comparative example, differences between output signals convolved with HRIRs in the sound-source directions and “approximate values” were calculated as SNRs.

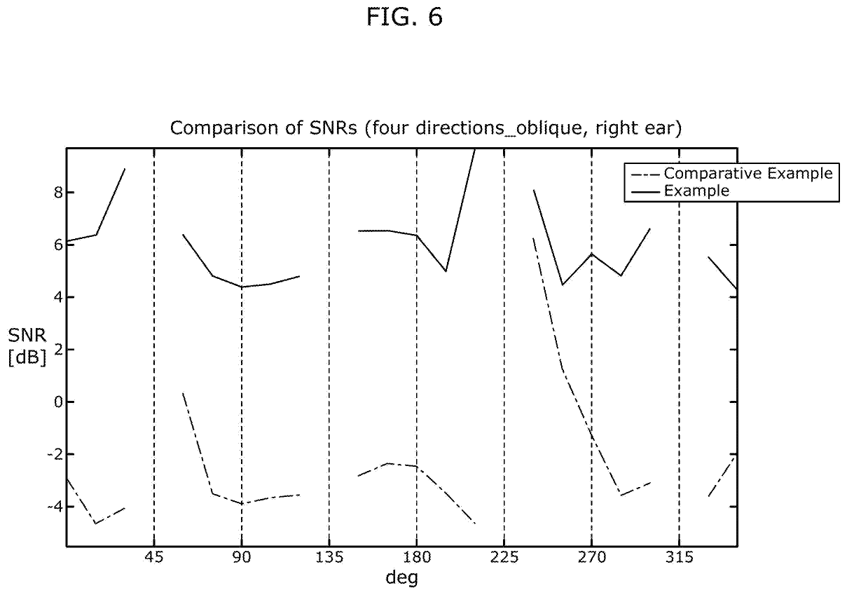

The results are explained with reference to FIG. 6 to FIG. 11. In the drawings, the horizontal axis indicates angle, whereas the vertical axis indicates SNR (dB, decibel).

FIG. 6 illustrates results of comparing SNRs (four directions_oblique, right ear).

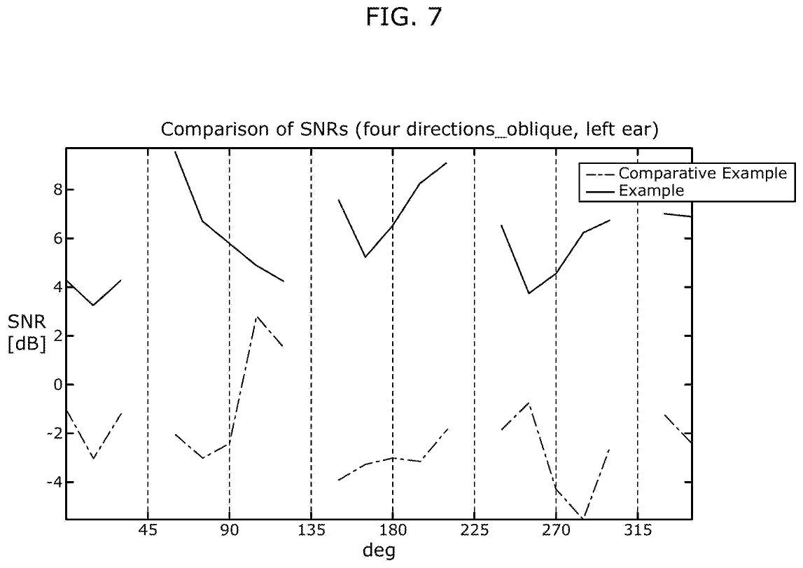

FIG. 7 illustrates results of comparing SNRs (four directions_oblique, left ear).

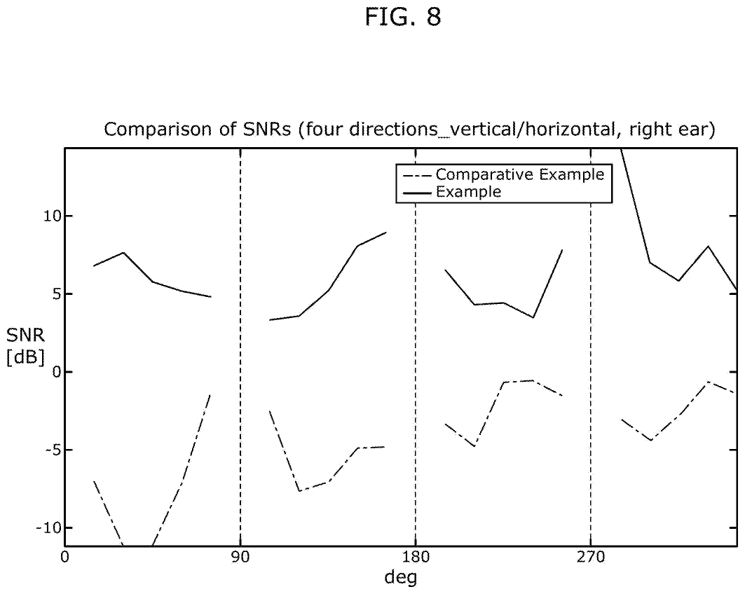

FIG. 8 illustrates results of comparing SNRs (four directions_vertical/horizontal, right ear).

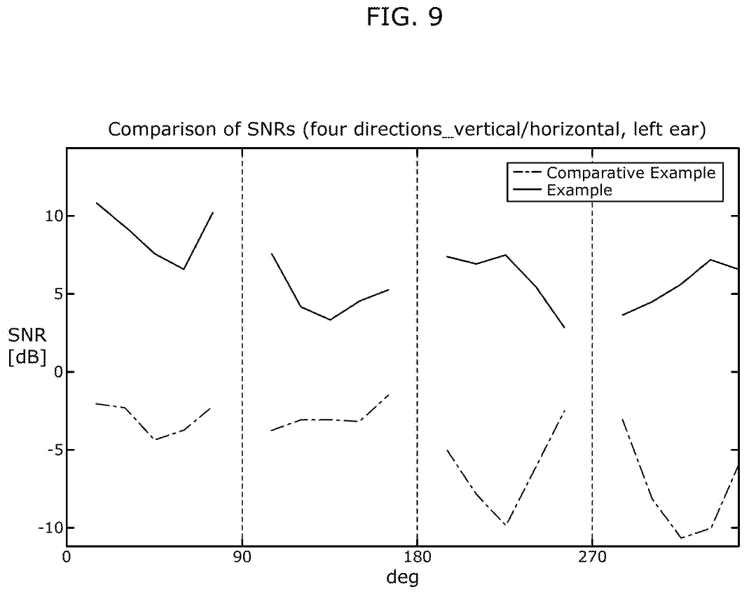

FIG. 9 illustrates results of comparing SNRS (four directions_vertical/horizontal, left ear).

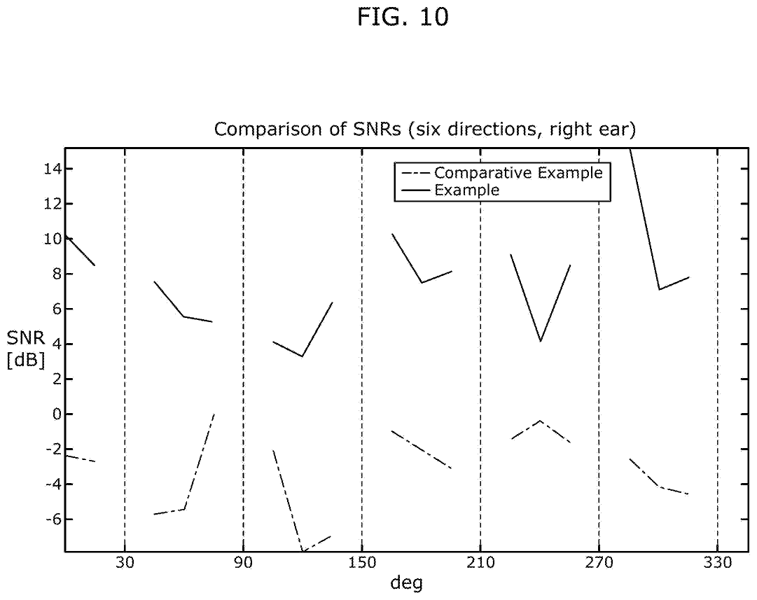

FIG. 10 illustrates results of comparing SNRs (six directions, right ear).

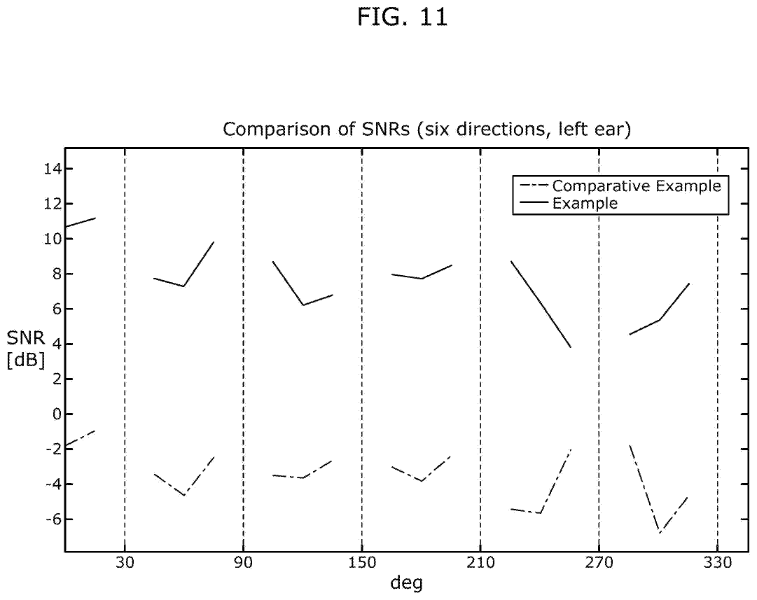

FIG. 11 illustrates results of comparing SNRs (six directions, left ear).

In all the comparisons, the SNR was higher than that in the comparative example, by 5 dB to 10 dB. Accordingly, the SNR was able to be improved by using the panning according to this Example, as compared to the case where the conventional technique was used.

### (Localization Experiments Based on Subjective Evaluation)

Next, experiments (localization experiments) for measuring subjective localization were conducted with a subject, using a true value convolved with an HRIR of an original and an approximate value obtained by the panning in this Example. Table 1 below shows the conditions for the localization experiments.

TABLE 1

| | |
|---|---|
| Presented angle | 0 degrees to 345 degrees, |
| | intervals of 15 degrees |
| Used sound source | White noise |
| Used method | True values, comparative example |
| | (three variations), Example (three |
| | variations) |
| Presented sound pressure | 70 dB (true value, 0 degrees) |
| Used headphones | SENNHEISER HD 580 precision |
| Number of iterations | Two times |

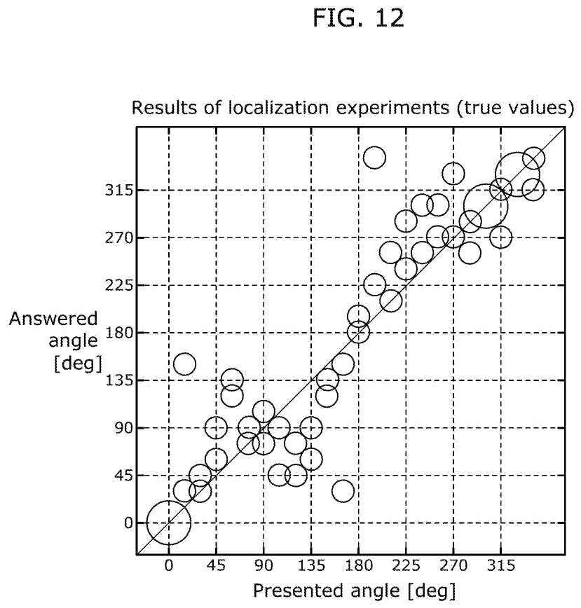

Out of these, a presented sound pressure was measured using a dummy head wearing headphones and a measuring amplifier. FIG. 12 to FIG. 15 illustrate the results of the experiments. In the graphs, the horizontal axis indicates a sound-source direction presented, whereas the vertical axis indicates a direction that a listener answered. Thus, if the answer is on an oblique line of 45 degrees, this shows that the listener correctly perceives the presented sound-source direction. With regard to the size of a circle, a large circle shows that answers were the same in two trials, whereas a small circle shows that answers were different in two trials.

FIG. 12 illustrates the results of localization experiments using true values, in which subjective localization of sound source S was conducted. The results obtained using true values in FIG. 12 show that the sound-source directions indicated by a listener as answers were mostly correct although some of the answers were off the line in the oblique direction. Thus, most of the answers were along the line of 45 degrees in the graph.

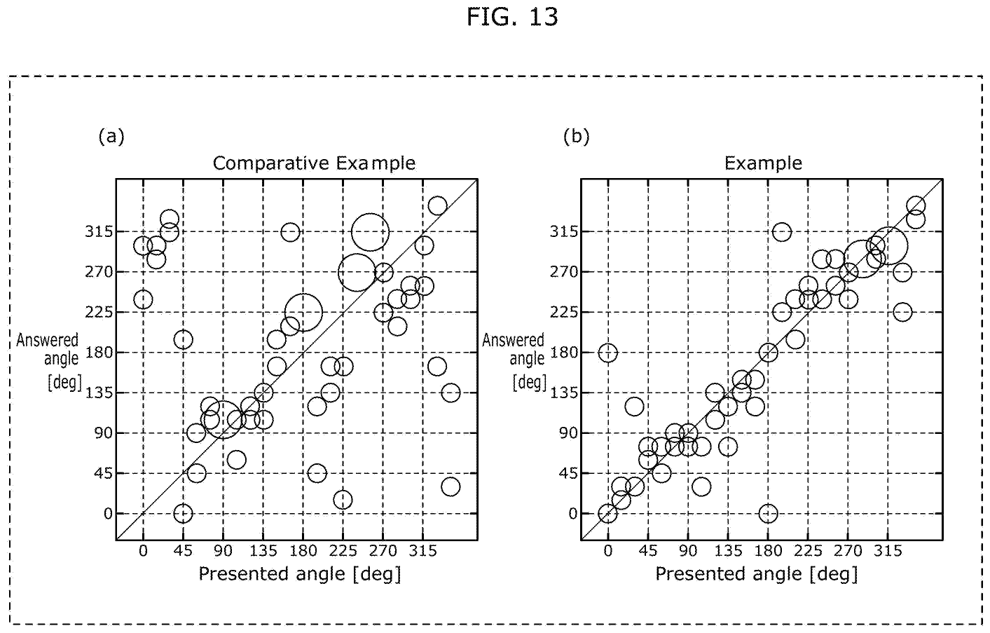

FIG. 13 illustrates results of localization experiments using representative points in (1) four directions_oblique stated above.

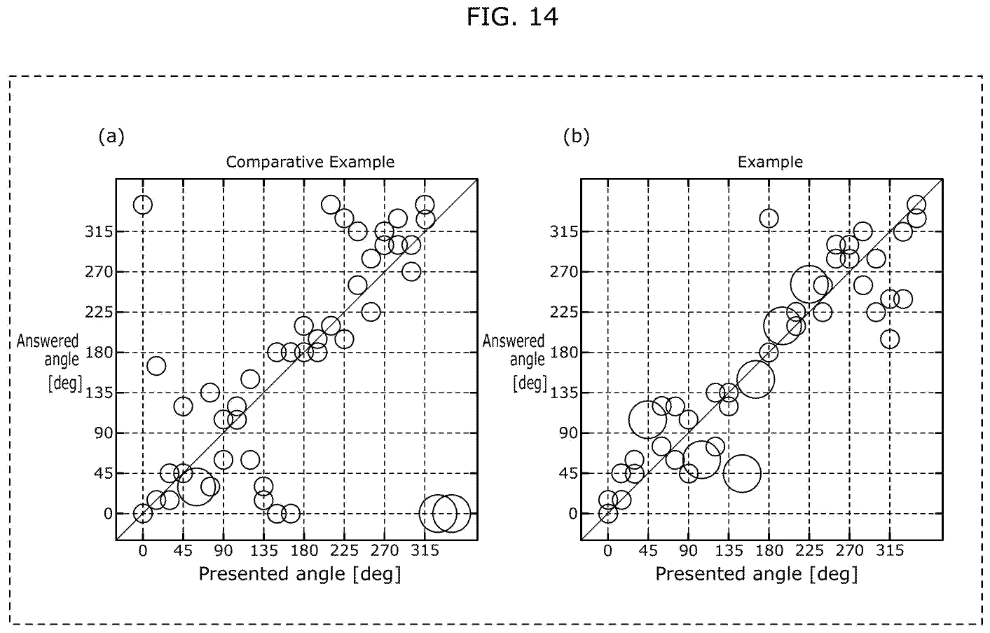

FIG. 14 illustrates results of localization experiments using representative points in (2) four directions_vertical/horizontal stated above.

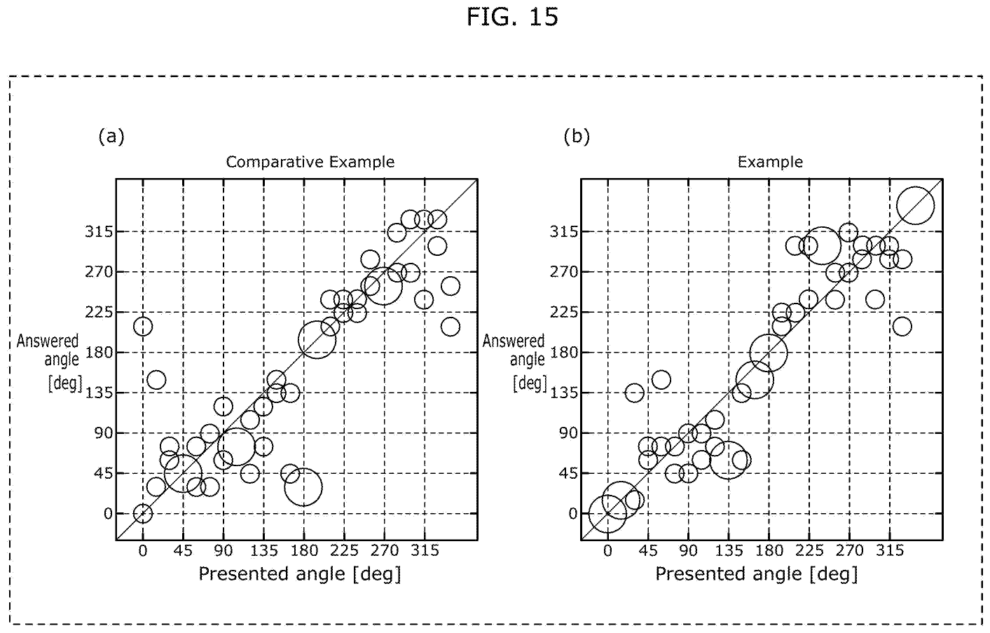

FIG. 15 illustrates results of localization experiments using representative points in (3) six directions stated above.

In FIG. 13 to FIG. 15, (a) is an example in which gains were used based on the sine law as a comparative example, whereas (b) shows approximate values obtained by panning for the representative points in this Example.

As a result, in all the variations of the comparative example in which panning was performed based on the sine law, although a degree of recognizing the sound-source direction was higher to some extent in the case of the six directions than the four directions, a listener was not able to correctly recognize the sound-source direction very much.

In contrast, the answers are substantially on the lines defined by 45 degrees with approximate values obtained by panning for the representative points in this Example, which is quite close to the case with true values. It can be seen that most of the answers with the approximate values in this Example are on the line defined by 45 degrees. Thus, with the approximate values in this Example, the number of representative points can be decreased, and the listener were able to sufficiently recognize the sound-source direction using representative points in about four directions.

Thus, when white nose was used in the panning in this Example, a listener was able to sufficiently recognize the sound-source direction as compared with the case using HRIRs of the originals.

(Subjective Quality Evaluation by Multiple Stimuli with Hidden Reference and Anchor (MUSHRA))

Next, how much the tone of sound source S changed was evaluated using a speech sound source. Specifically, whether an approximate value by panning in this Example was changed as compared with a result obtained by convolving an HRIR of an original with the speech sound source was evaluated by Multiple Stimuli with Hidden Reference and Anchor (MUSHRA) for measuring subjective audio quality defined by ITU-R BS.1534.

Here, similarly to other assessment stated above, the comparative example, HRIRs of the originals, and the synthesized HRIR of panning in this Example were convolved with the Japanese Versatile Speech corpus (JVS) (<URL=“https://sites.google.com/site/shinnosuketakamichi/research-topic s/jvs_corpus”>), and (true values) and (approximate values) were generated and evaluated. Table 2 below shows the conditions for experiments by MUSHRA.

TABLE 2
Conditions for experiment

| | |
|---|---|
| Presented angle | Angles that do not correspond to |
| | representative points using three |
| | types of methods (*) |
| Used sound source | JVS corpus (two types of male |
| | voice and two types of female |
| | voice) |
| Convolved HRIR | True values, comparative example |
| | (three variations), Example (three |
| | variations) |
| Presented sound pressure | 70 dB (result of convolving HRIR |
| | of original, 0 degrees) |
| Used headphones | SENNHEISER HD 580 precision |

(*) 12 different degrees, that is, 15, 60, 75, 105, 120, 165, 195, 240, 255, 285, 300, and 345 degrees

In this experiment, other than the angle at which a sound source is present, after a subject listened to a result (true value) obtained by convolving an HRIR of an original with a speech sound, the subject randomly listened to evaluations of the variations of Example and the comparative example, including (true values), and made evaluations being blinded.

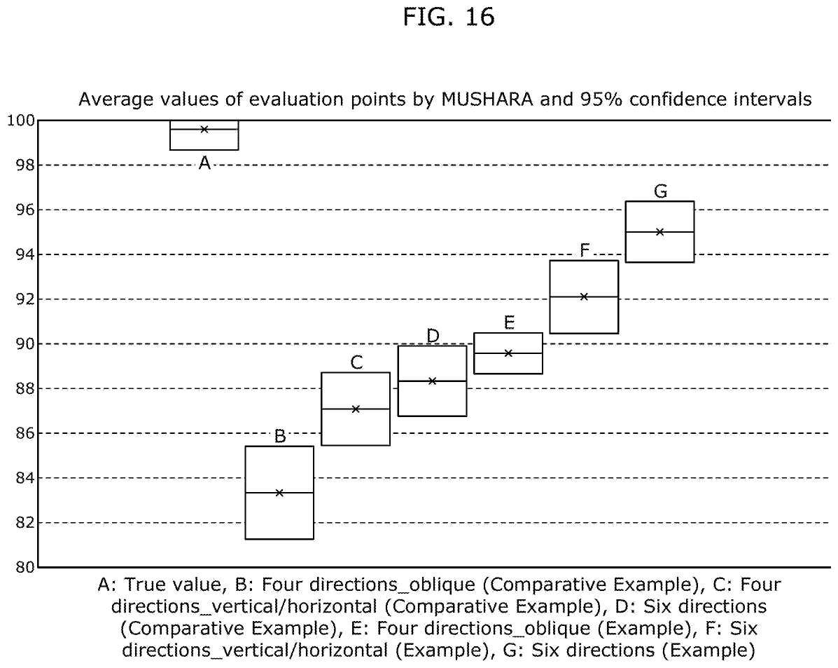

FIG. 16 illustrates results of experiments of subjective quality evaluation (one type of male voice) by MUSHRA. With regard to the graphs, A shows an original (true value), B shows four directions_oblique (comparative example), C shows four directions_vertical/horizontal (comparative example), D shows six directions (comparative example), E shows four directions_oblique (Example), F shows six directions_vertical/horizontal (Example), and G shows six directions (Example). In all the graphs, the vertical axis indicates an evaluation point, a portion of a horizontal bar marked with X shows an average value of the evaluation points, and the height of the bar shows 95% confidence interval.

As a result, the ranking was in the order of the original (true value), the Examples, and the comparative examples. Thus, it can be seen that the panning according to the Examples achieves evaluation points close to the point achieved with the HRIR of the original, and the evaluation points are higher than the evaluation points obtained by the conventional sine law.

### (Comparison of SNRs Using HRIRs in FABIAN)

The HRIRs of originals stated above were obtained at 15-degree intervals. Accordingly, in order to conduct objective evaluations in a narrower angle range, FABIAN (<URL=“https://depositonce.tu-berlin.de/handle/11303/6153”> that is an HRIR database, which is an open source frequently used by persons skilled in the art. FABIAN includes data obtained at 2-degree intervals. The data included in FABIAN is not HRIRs of the subject himself/herself, and thus only objective SNR evaluation was performed on results of the panning in this Example, and the results were checked.

The representative points used in this Example are the same as those in the above case where the originals were used. Thus, representative point directions were set at (1) a range angle of 90 degrees (45 degrees, 135 degrees, 225 degrees, and 315 degrees), (2) a range angle of 90 degrees (0 degrees, 90 degrees, 180 degrees, and 270 degrees), and (3) a range angle of 60 degrees (30 degrees, 90 degrees, 150 degrees, 210 degrees, 270 degrees, and 330 degrees). The sets of the representative points are referred to as (1) four directions_oblique, (2) four directions_vertical/horizontal, and (3) six directions.

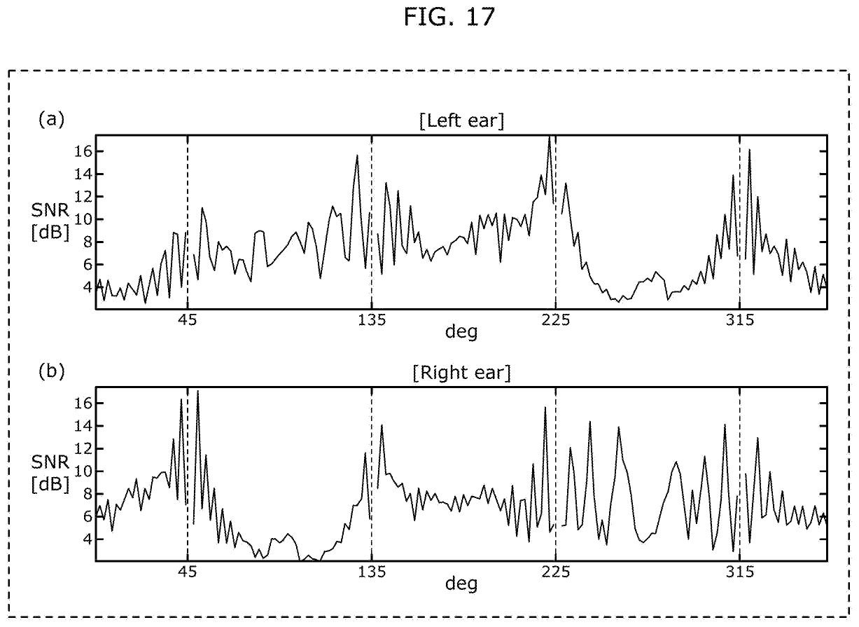

Also in the panning in this Example in which FABIAN was used, a time shift was applied using a cross-correlation, and gains obtained by vector calculation were used. The results are explained with reference to FIG. 17 to FIG. 23. In the drawings, the horizontal axis indicates angle, whereas the vertical axis indicates SNR (dB, decibel). In FIG. 17 to FIG. 19, (a) shows the results of a left ear, whereas (b) shows the results of a right ear.

FIG. 17 illustrates (1) results regarding SNRs (four directions_oblique).

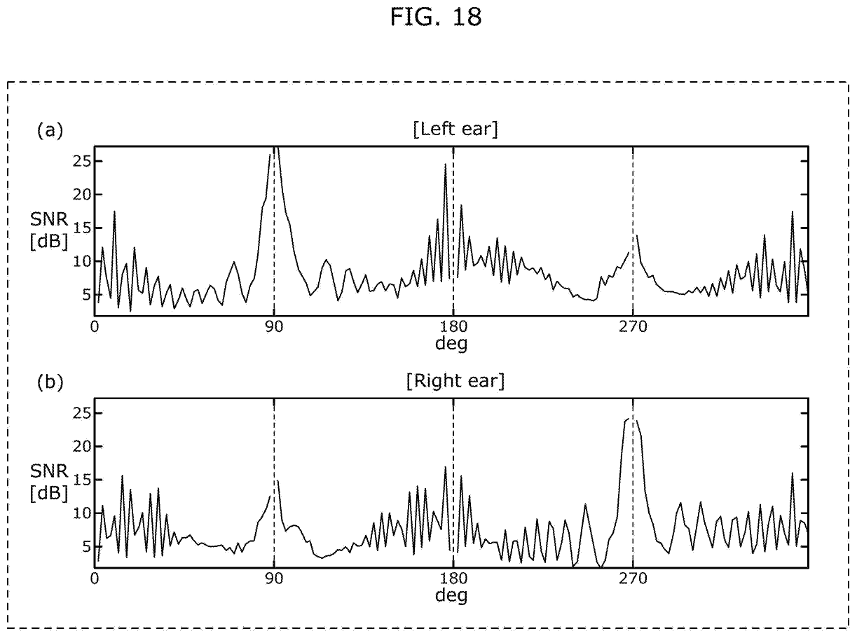

FIG. 18 illustrates (2) results regarding SNRs (four directions_vertical/horizontal).

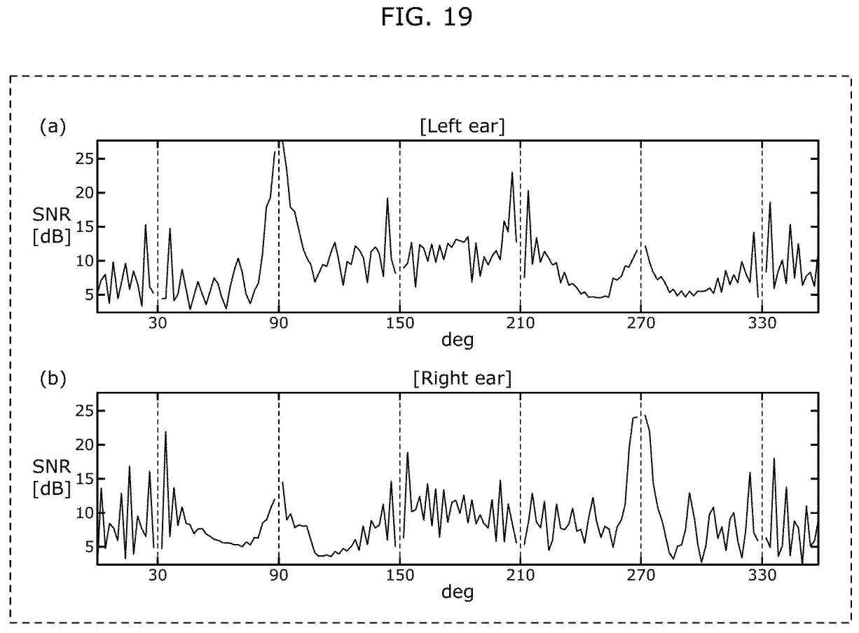

FIG. 19 illustrates (3) results regarding SNRs (six directions).

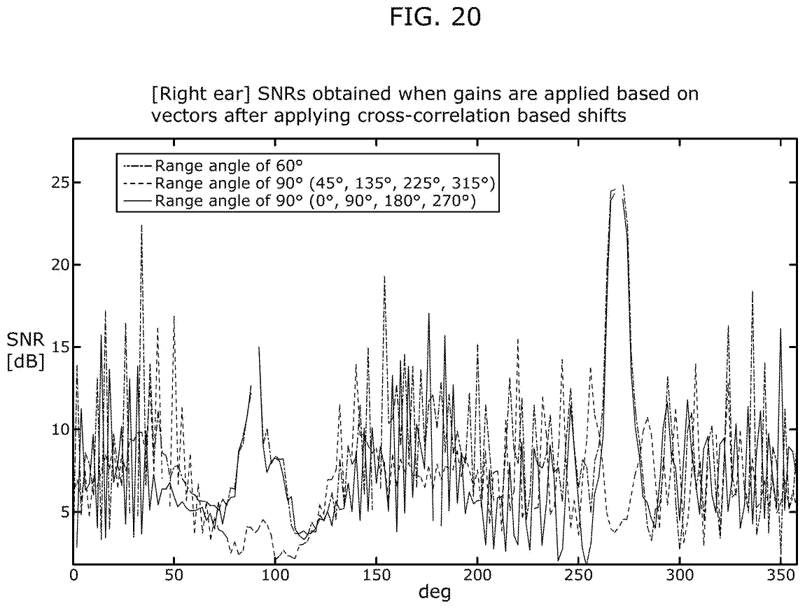

FIG. 20 illustrates results of comparing SNRs (right ear) in which three types of (1) to (3) are put together.

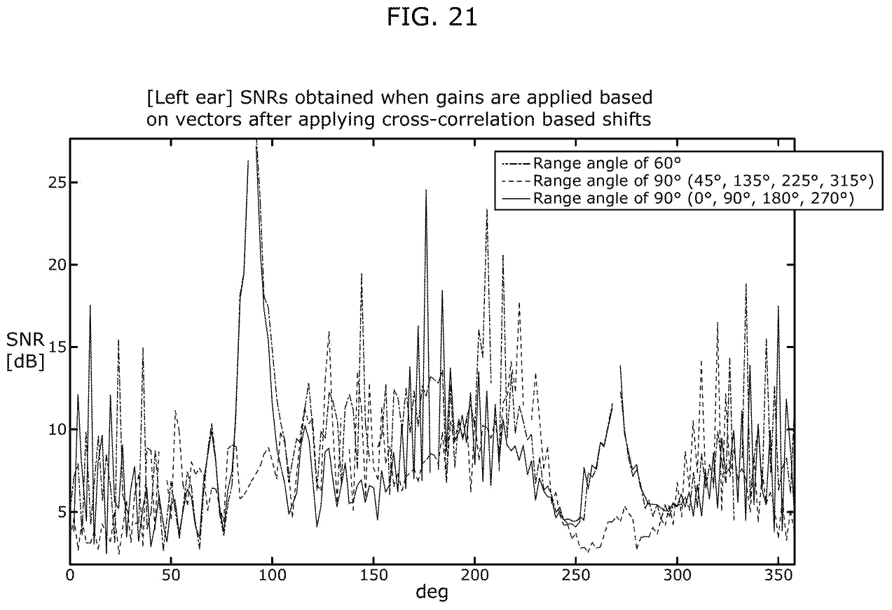

FIG. 21 illustrates results of comparing SNRs (left ear) in which three types of (1) to (3) are put together.

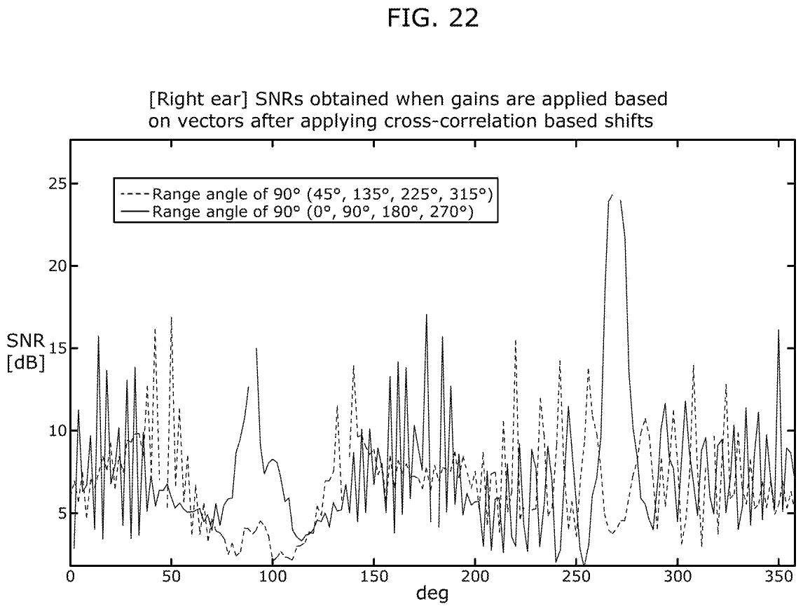

FIG. 22 illustrates results of comparing SNRs (right ear) only in four directions of (1) and (2).

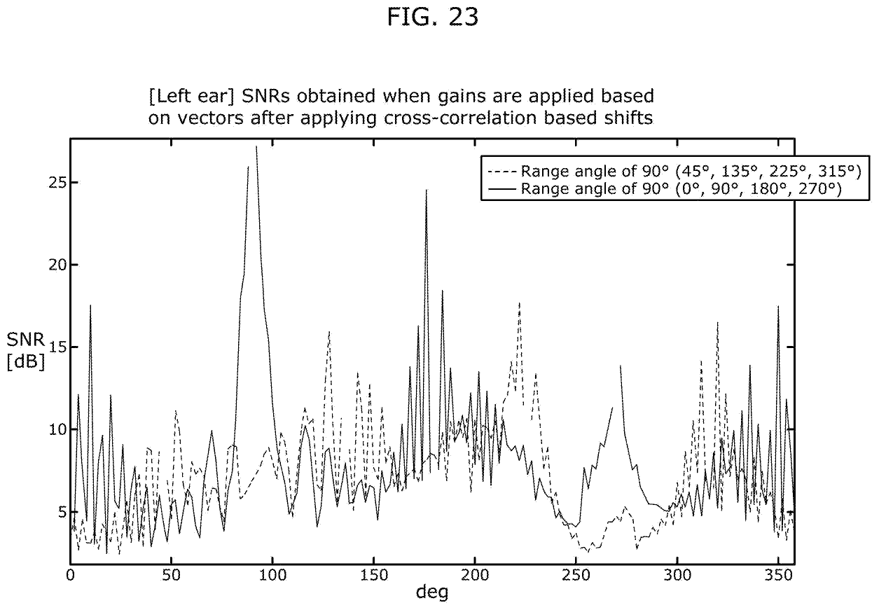

FIG. 23 illustrates results of comparing SNRs (left ear) only in four directions of (1) and (2).

According to FIG. 17 to FIG. 19, obtained results show SNRs of 10 dB at good angles and SNRs of about 6 dB at bad angles in the case of the four directions. Furthermore, results obtained in the case of (2) four directions_vertical/horizontal were better than those in the case of (1) four directions_oblique. Thus, in the case of four directions_vertical/horizontal, an SNR of over 20 dB was obtained at good angles, and an SNR of about 10 dB was obtained at bad angles. Since FABIAN includes data for 2 degree intervals, and thus behavior at each angle interval was readily seen.

FIG. 20 to FIG. 21 show determination as to which of the cases of the four directions and the six directions yields the best result, by superposing all the results obtained in the cases. The conclusion was that the four directions seemed to be sufficient.

FIG. 22 to FIG. 23 show determination as to which of the vertical/horizontal case or the oblique case yields better results by overlapping only the cases of the four direction. As a conclusion, it can be seen from the graphs that (2) four directions_vertical/horizontal was better than (1) four directions_oblique, and it was better to use four vertical/horizontal positions than to use oblique positions.

### (Effects Yielded by Decimal Shifts)

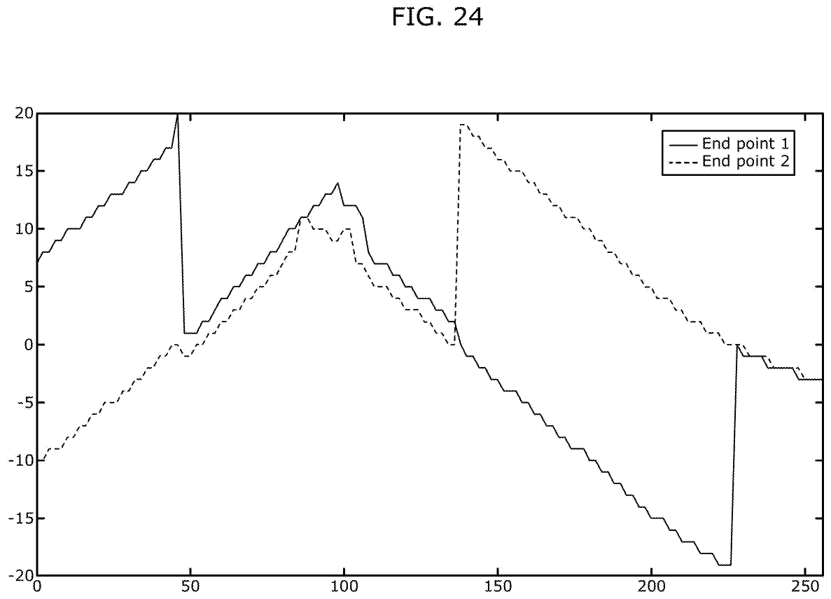

In the above verification using FABIAN, SNRs at adjacent angles have great differences to make a comb shape. Accordingly, the time shift amounts used in the panning in this Example were checked. FIG. 24 to FIG. 29 illustrate time shift amounts at which a cross-correlation is highest at each angle. In all the drawings, the horizontal axis indicates angle, whereas the vertical axis indicates a time shift amount (the number of samples). “End point 1” denotes representative point R-1, and “end point 2” denotes representative point R-2.

FIG. 24 illustrates computation results of time shift amounts (four directions_oblique, right ear).

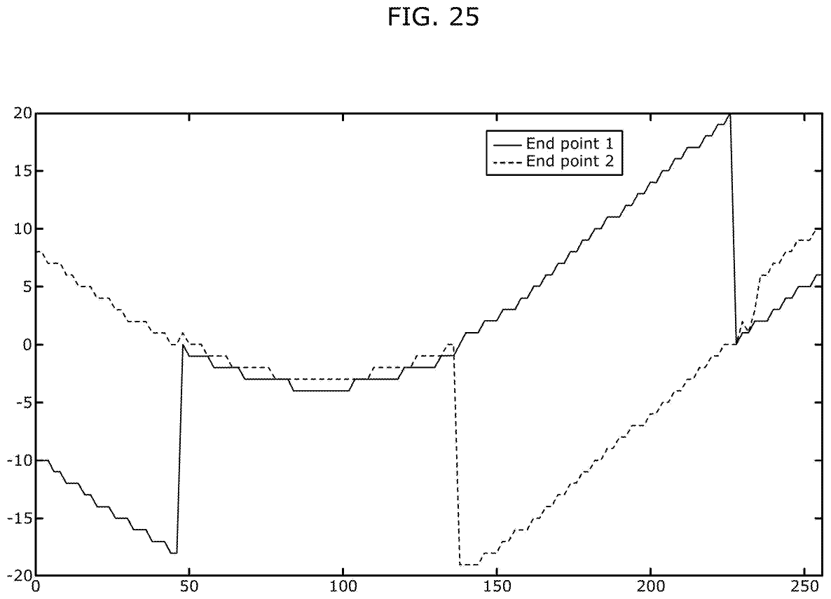

FIG. 25 illustrates computation results of time shift amounts (four directions_oblique, left ear).

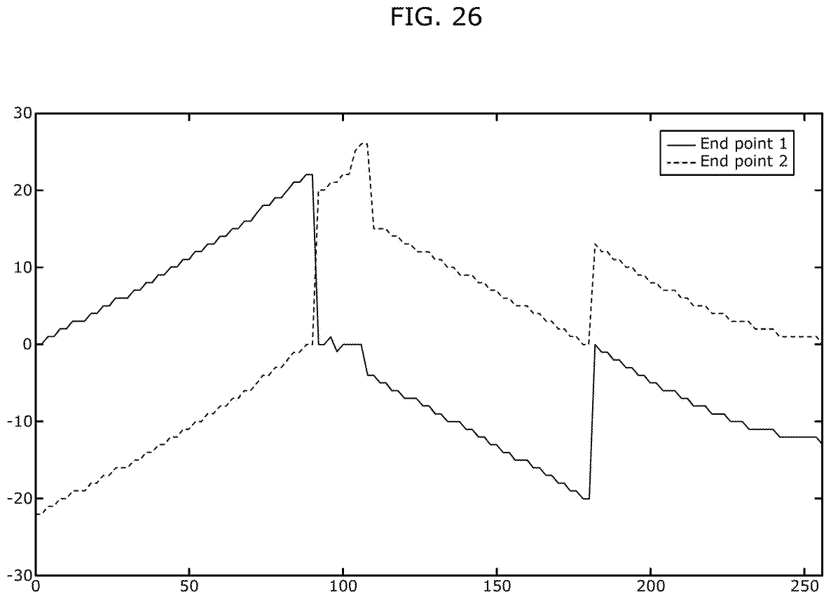

FIG. 26 illustrates computation results of time shift amounts (four directions_vertical/horizontal, right ear).

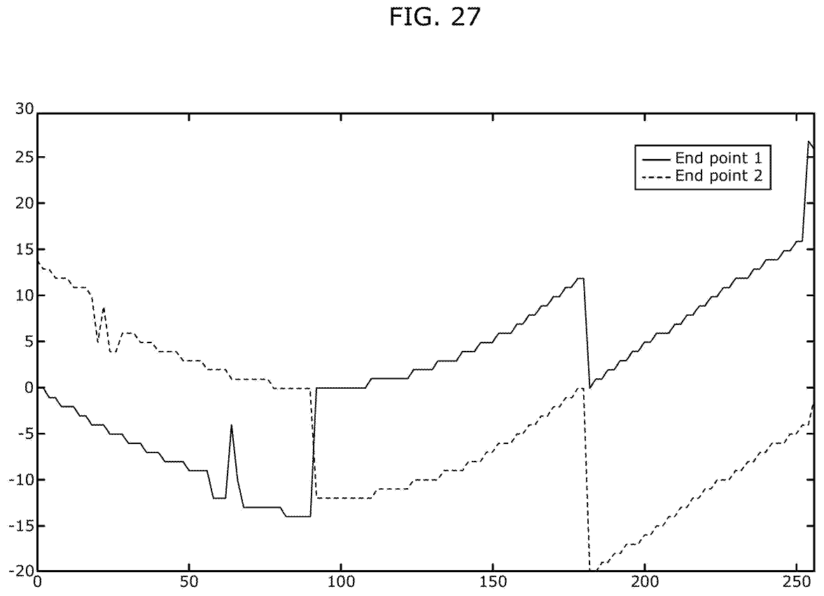

FIG. 27 illustrates computation results of time shift amounts (four directions_vertical/horizontal, left ear).

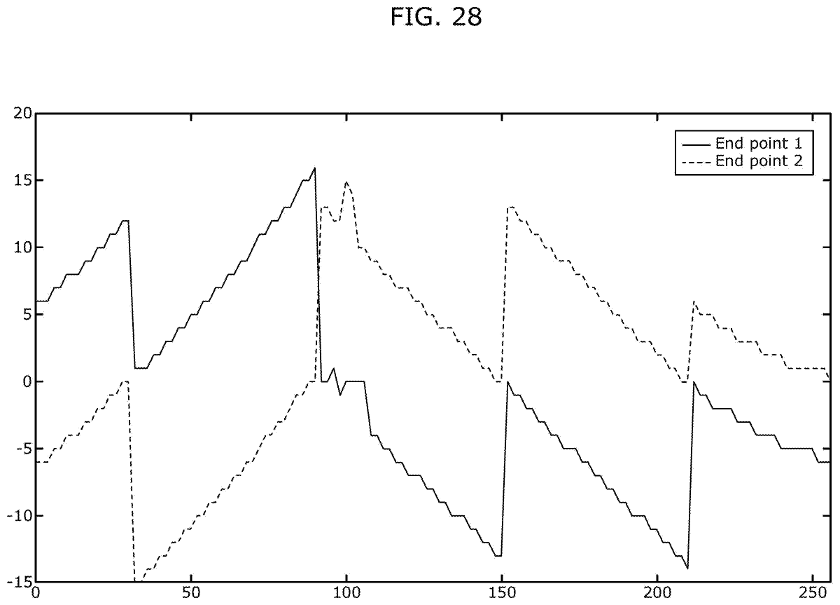

FIG. 28 illustrates computation results of time shift amounts (six directions, right ear).

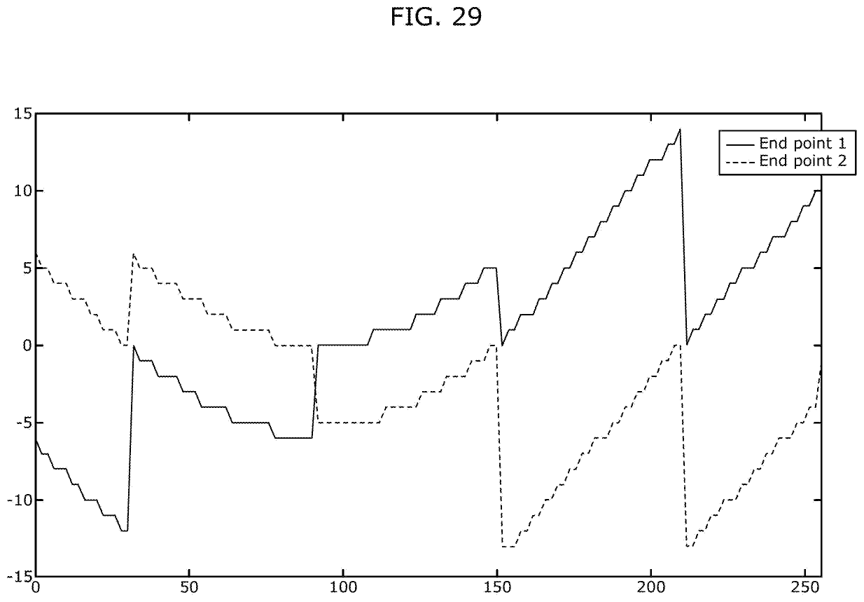

FIG. 29 illustrates computation results of time shift amounts (six directions, left ear).

In all the graphs, the time shift amounts are equal at some points, even at 2-degree intervals. Here, in the above Example, a time shift that maximizes the cross-correlation was applied, but the shift was applied by an integer value only. Accordingly, it was considered to include a portion where the amount by which a shift was to be originally applied and the actual amount of shift were different. For example, it was considered to include a portion where the amount of shift was intended to be 0.6 sample, but the actual amount of shift turned out to be 1 sample.

Thus, with regard to a sampling frequency of sound source S, only a time shift by an integer value was conducted, so the shift amount was an integer even if an optimal shift sample has a value of a decimal. Accordingly, the inventors of the present application verified that by performing oversampling to enable a substantial decimal shift, considering that a difference in shift amount could be reduced and an improvement in SNR could be expected. Thus, the inventors conceived to maximize a cross-correlation by applying a shift by 0.5 sample or a shift by 0.25 sample, for instance.

Here, four-time oversampling was performed, and a comparison between SNRs with the case of an integer shift (Example) was made. Specifically, the inventors verified that the cross-correlation would be maximized by causing 48 KHz sampling used for HRIRs in FABIAN to be 192 KHz sampling by four-time oversampling.

This is because the length in a space of 1 sample in 48 KHz sampling is about 0.7 cm, the length in a space per 1 sample is about 0.18 cm by four-time oversampling, and thus this much of resolution was considered to be sufficient when the sizes of the face and ear of a person were considered.

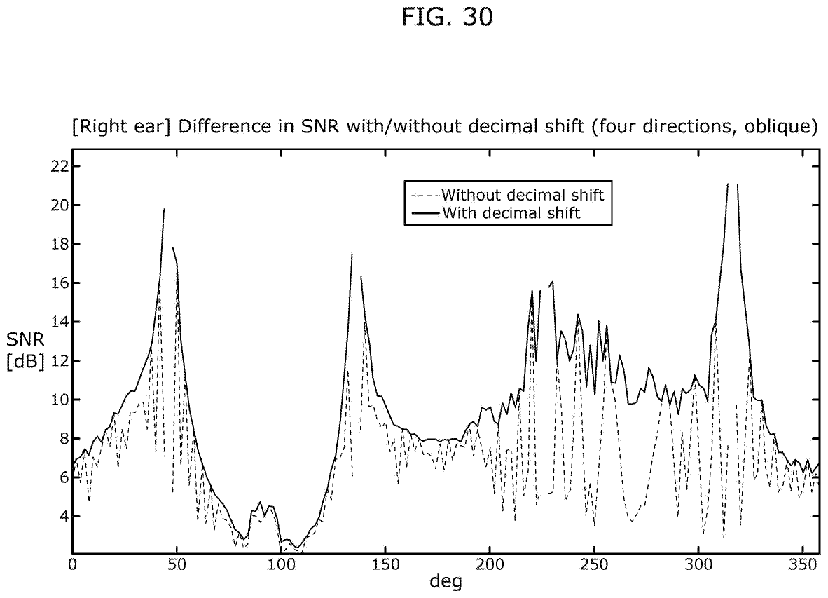

Effects achieved by applying decimal shifts by oversampling in this manner were verified using HRIRs in FABIAN. FIG. 30 to FIG. 35 show results of comparing SNRs between an integer multiple shift and a decimal shift. In all the graphs, the horizontal axis indicates angle, whereas the vertical axis indicates SNR (dB, decibel).

FIG. 30 illustrates results of comparing SNRs (four directions_oblique, right ear).

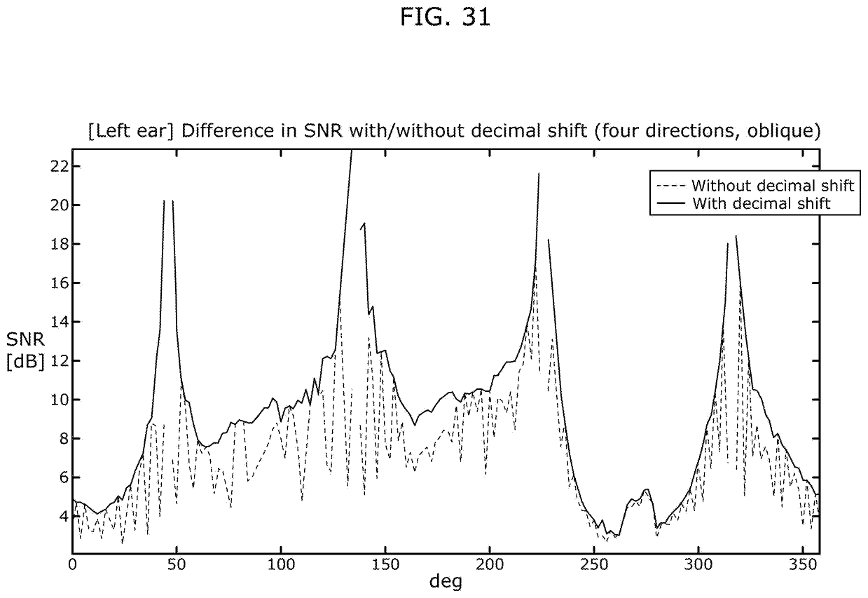

FIG. 31 illustrates results of comparing SNRs (four directions_oblique, left ear).

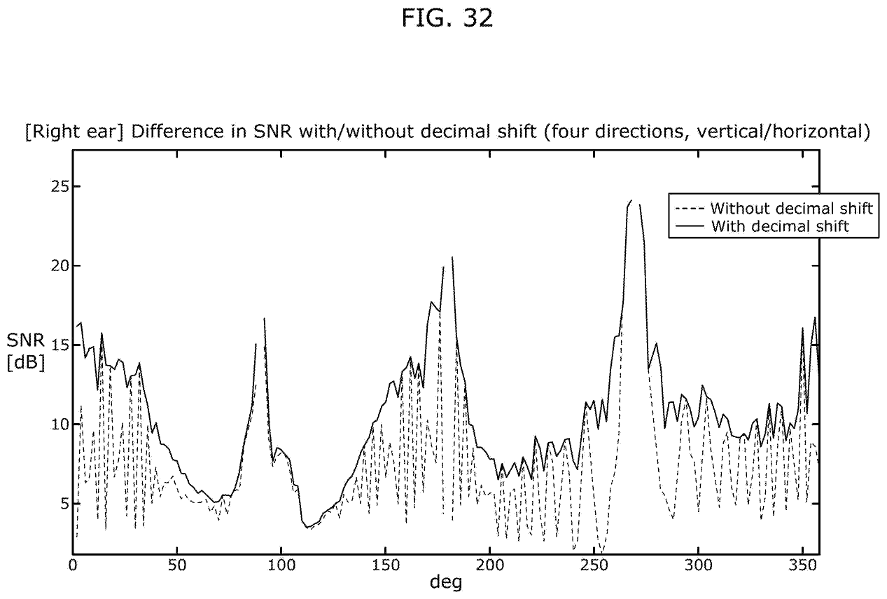

FIG. 32 illustrates results of comparing SNRs (four directions_vertical/horizontal, right ear).

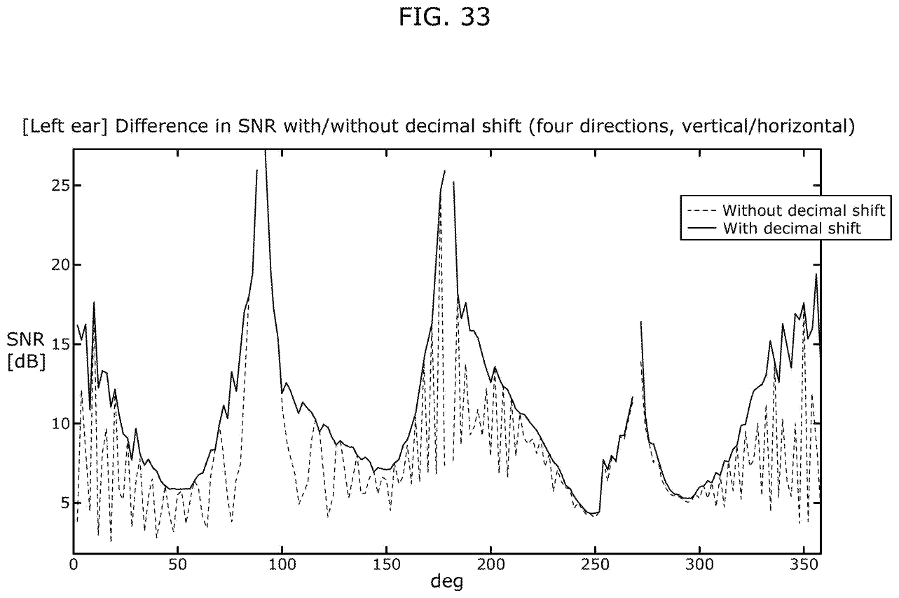

FIG. 33 illustrates results of comparing SNRs (four directions_vertical/horizontal, left ear).

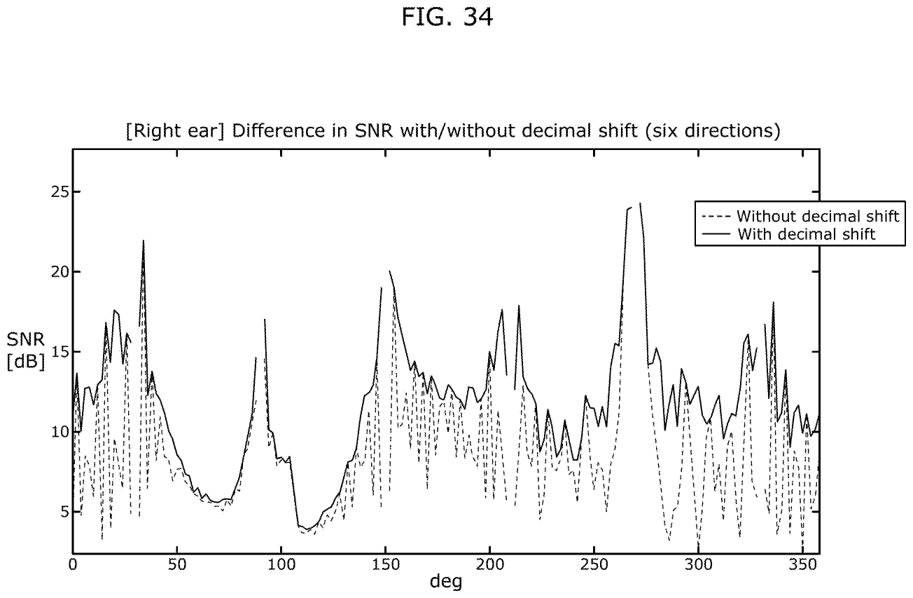

FIG. 34 illustrates results of comparing SNRs (six directions, right ear).

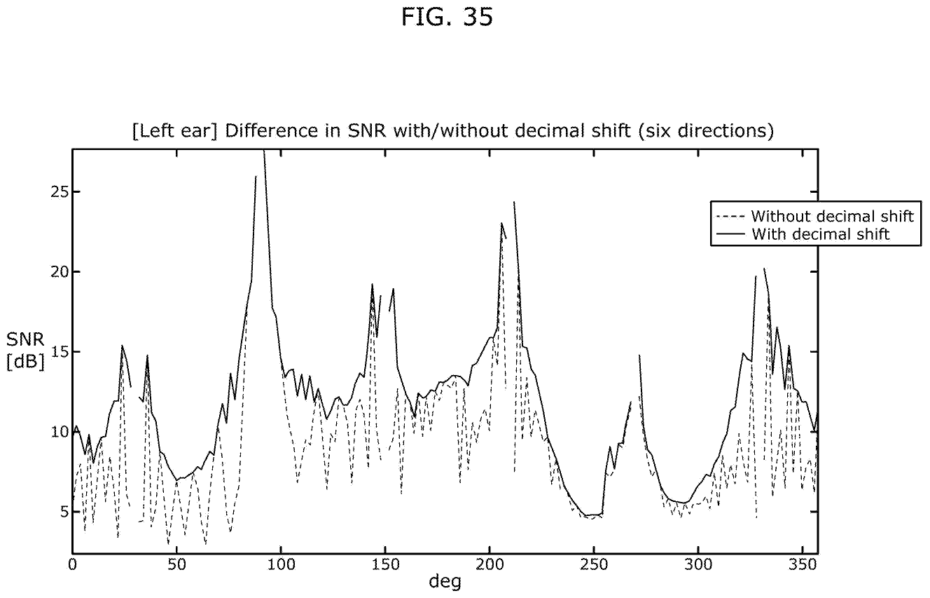

FIG. 35 illustrates results of comparing SNRs (six directions, left ear).

In all the cases, by applying a decimal shift, a comb-shaped change in SNR depending on an angle was reduced, and an SNR was further improved.

### (Examination of Computation Amount)

Next, performing oversampling to apply a decimal shift increases an amount of computation, and thus such an increase in an amount of computation due to this was examined. Specifically, by roughly estimating an amount of computation, an increase in the amount of computation caused by oversampling was roughly estimated and checked.

An amount of computation was roughly estimated under the following conditions.
The number of sound source objects (sound sources S) in a range angle: M
The number of taps of an HRIR: L
The order of oversampling filter for decimal shift: N
(when N-order oversampling is performed)

A time-shift value indicating what point shift (a decimal included: such as 3.25 points) was applied in M-time oversampling was calculated in advance for each of the directions of sound sources S (sound-source direction) of HRIRs. A time shift was applied on sound source S, based on the time shift value.

As a comparative example, for each sound source S, the amounts of computation in the case where an HRIR in the direction of sound source S (sound-source direction) was directly convolved and the case where the panning according to this Example was used are shown by (α), (β), and (γ) below.
(α) When panning is not performed and convolution is performed for each
An amount of computation necessary for 1 sample (the number of sums of products): ML
(β) When oversampling is performed and panning in which a decimal shift is allowed is performed
Calculation of one oversampling point: 2N
Oversampling is performed for all sound sources S: 2MN

$$Calculation of value of representative point : 2 M + 2 ( M - 1 ) \approx ( Application of gain values to two representative points ) + ( Generation of a sum signal for two representative points )$$

Convolution: 2L
The amount of computation necessary for 1 sample (the number of sums of products): 2MN+2M+2(M−1)+2L
(γ) When oversampling is not performed (reference)

The amount of computation necessary for 1 sample (the number of sums of products): 2M+2(M−1)+2L
Here, a specific example of comparing amounts of computation obtained by the techniques stated in (a) and (B) above is to be explained. In either case, order N of an oversampling filter is 16.
i. In the case where the number of sound source objects: M=3, the number of taps of an HRIR: L=256
Amount of computation by (α): 3×256=768
Amount of computation by (β):

$$2 \times 3 \times 16 + 2 \times 3 + 2 ( 3 - 1 ) + 2 \times 256 = 618$$

ii. In the case where the number of sound source objects: M=4, the number of taps of an HRIR: L=256
Amount of computation by (α): 4×256=1024
Amount of computation by (β):

$$2 \times 4 \times 16 + 2 \times 4 + 2 ( 4 - 1 ) + 2 \times 256 = 654$$

As a result, in both the cases, the number of sums of product was reduced to 65% to 80%.

### (Examples of Waveforms)

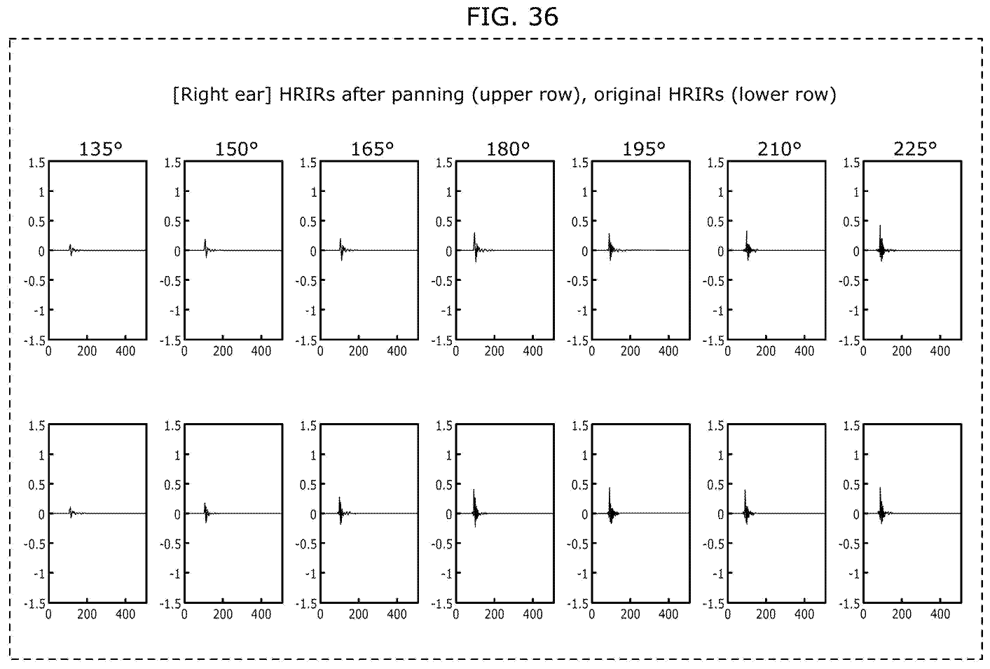

FIG. 36 illustrates examples of comparing waveforms of synthesized HRIRs by the panning in the Example explained above and waveforms of HRIRs of a subject himself/herself (original). Here, representative examples of comparing waveforms (four directions_oblique) of the rear (135 degrees to 225 degrees) are shown. The upper part of the drawing shows waveforms of synthesized HRIRs by the panning in the Example, and the lower part of the drawing shows waveforms of original HRIRs.

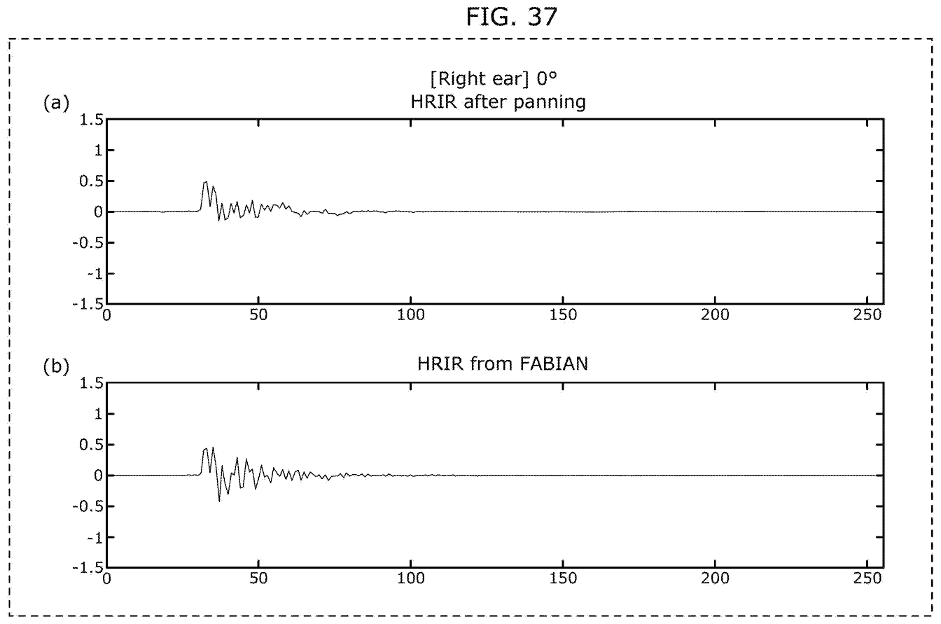

FIG. 37 illustrates representative examples of comparing waveforms of synthesized HRIRs by the panning in the Example explained above and waveforms of HRIRs in FABIAN. Here, with regard to the waveforms of (four directions_oblique, right ear), the upper drawing shows a waveform of a synthesized HRIR by the panning in this Example, and the lower drawing shows a waveform of an HRIR in FABIAN.

It was able to be seen that both waveforms were quite similar. The same applied to the other waveforms. Thus, accurate approximation was achieved by the panning in this Example. Thus, an HRIR in a sound-source direction was able to be equivalently generated using an HRIR in a representative direction, by synthesizing the sound source by panning in the particular representative direction.

### Example 2

An HRIR was generated, a cross-correlation of which was calculated by applying a weighting filter for an impulse response of an LPF having a cut-off frequency of 3000 Hz and an attenuation slope of 8 dB/Oct stated in Embodiment 2 above, and was compared with an original HRIR and an HRIR to which a weighting filter was not applied.

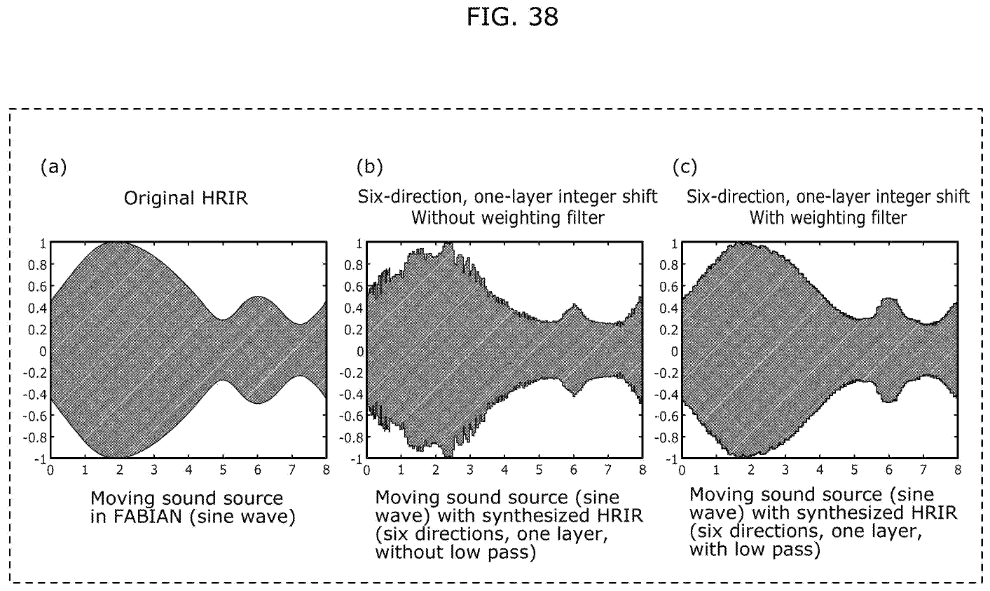

Specifically, FIG. 38 illustrates results of measuring envelopes of waveforms input to a left ear when a 1-kHz sine wave went around the head counterclockwise from the front side taking 8 seconds. Part (a) of FIG. 38 illustrates a result obtained using an HRIR of an original, (b) illustrates a result of measuring an HRIR in six directions by applying thereto one-layer integer shift without a weighting filter being applied in the comparative example, and (c) illustrates a result of measuring an HRIR in six directions with a weighting filter being applied by applying one-layer integer shift in this Example.

As a result, an HRIR of a moving sound source could be smoothly transitioned by applying the weighting filter, in a closer manner to an HRIR of an original, as compared with the comparative example.

Note that the configurations in the above embodiments and operations are examples, and can be changed and executed as appropriate without departing from the scope of the present disclosure.

### INDUSTRIAL APPLICABILITY

The sound generation device according to the present disclosure can reduce a load by decreasing the amount of computation when a stereophonic sound is generated, and is industrially applicable.

1. A sound generation device comprising:
a direction obtainer that obtains a sound-source direction of a sound source; and
a panner that expresses the sound source, by applying a time shift and gain adjustment to the sound source to perform panning for distributing a signal of the sound source to a plurality of representative directions, based on the sound-source direction obtained by the direction obtainer.

2. The sound generation device according to claim 1,
wherein the panner sums distributed signals of the sound source at a plurality of representative positions for synthesizing a sound image of the sound source by using sounds from the plurality of representative directions.

3. The sound generation device according to claim 2,
wherein the panner applies, to the sound source,
a time shift calculated to maximize a cross-correlation between a head-related impulse response for the sound-source direction and a head-related impulse response for each of the plurality of representative directions, or
a minus-sign time shift resulting from assigning a minus sign to the time shift.

4. The sound generation device according to claim 3,
wherein a result obtained by calculating the cross-correlation after applying a weighting filter in a frequency domain is used for the time shift, a gain, or the time shift and a gain.

5. The sound generation device according to claim 3,
wherein for each of the plurality of representative positions, the panner applies a gain to the sound source, the gain being set for the sound source and a representative direction for the representative position.

6. The sound generation device according to claim 5,
wherein when a head-related impulse response (HRIR) vector for the sound-source direction is synthesized by using a sum of HRIR vectors for the plurality of representative directions to obtain a synthesized HRIR vector, the panner uses the gain calculated to cause an error signal vector between the synthesized HRIR vector and the HRIR vector for the sound-source direction to be orthogonal to each of the HRIR vectors for the plurality of representative directions.

7. The sound generation device according to claim 5,
wherein the panner uses the gain calculated to minimize an L2 norm or energy of an error signal vector between a synthesized head-related impulse response (HRIR) vector and an HRIR vector for the sound-source direction.

8. The sound generation device according to claim 7,
wherein a result obtained by applying a weighting filter in a frequency domain is used for the error signal vector.

9. The sound generation device according to claim 5,
wherein the panner uses corrected gains, the corrected gains being used to maintain an energy balance between left and right ears in head-related impulse responses from a position of the sound source, in substantially synthesized head-related impulse responses by panning using head-related impulse responses from the plurality of representative positions.

10. The sound generation device according to claim 5,
wherein the panner applies the time shift to the sound source, treats signals to each of which the gain has been applied, as representative-position signals present at the plurality of representative positions, and convolves head-related impulse responses at the plurality of representative positions with a sum signal of the representative-position signals equal in number to a plurality of sound sources, to generate a signal that reaches an ear of a listener.

11. The sound generation device according to claim 3,
wherein in the time shift, a shift by a decimal of sampling is permitted.

12. The sound generation device according to claim 3,
wherein a reproduction high-frequency emphasis filter compensates a tendency for a high-frequency range to attenuate.

13. The sound generation device according to claim 1,
wherein the sound source is a sound signal of content or a sound signal of a participant of a remote call, and
the direction obtainer obtains a direction of the sound source in a view from a listener.

14. A sound reproduction device comprising:
the sound generation device according to claim 1; and
a sound outputter that outputs a sound signal generated by the sound generation device.

15. A sound generation method executed by a sound generation device, the sound generation method comprising:
obtaining a sound-source direction of a sound source; and
expressing the sound source, by applying a time shift and gain adjustment to the sound source to perform panning for distributing a signal of the sound source to a plurality of representative directions, based on the sound-source direction obtained.

16. A non-transitory computer-readable recording medium having recorded thereon a sound signal processing program executed by a sound generation device, the sound signal processing program causing the sound generation device to:
obtain a sound-source direction of a sound source; and
express the sound source, by applying a time shift and gain adjustment to the sound source to perform panning for distributing a signal of the sound source to a plurality of representative directions, based on the sound-source direction obtained.
